(19) United States
(12) Patent Application Publication
(10) Pub. No.: US 2024/0397362 A1
(43) Pub. Date: Nov. 28, 2024

(54) ENHANCED PERFORMANCE MEASUREMENTS RELATED TO ONE-WAY UPLINK PACKET DELAY IN WIRELESS COMMUNICATIONS

(71) Applicant: Intel Corporation, Santa Clara, CA (US)

(72) Inventor: Yizhi Yao, Chandler, AZ (US)

(73) Assignee: Intel Corporation, Santa Clara, CA (US)

(21) Appl. No.: 18/789,302

(22) Filed: Jul. 30, 2024

Related U.S. Application Data
(60) Provisional application No. 63/517,296, filed on Aug. 2, 2023.

(51) Int. Cl. H04W 24/10; H04L 41/12

(52) U.S. Cl. CPC H04W 24/10; H04L 41/12

(57) ABSTRACT

This disclosure describes systems, methods, and devices for performing performance measurements for one-way uplink packet delay in wireless communications. An apparatus of a Service Based Management Architecture (SBMA) Management Service (MnS) Producer may identify performance measurements, received from a network function (NF) of a 5^{th} Generation (5G) wireless network, indicative of uplink packet delay between a user equipment (UE) and a protocol data unit (PDU) session anchor (PSA) user plane function (UPF) of the 5G wireless network; detect whether the performance measurements indicate that the uplink packet delay includes an uplink PDCP delay occurred in the UE (D1); and generate performance metrics for the NF using the performance measurements.

### CROSS-REFERENCE TO RELATED PATENT APPLICATION(S)

This application claims the benefit of U.S. Provisional Application No. 63/517,296, filed Aug. 2, 2023, the disclosure of which is incorporated herein by reference as if set forth in full.

### TECHNICAL FIELD

This disclosure generally relates to systems and methods for wireless communications and, more particularly, to performance measurements related to one-way uplink packet delay in wireless communications.

### BACKGROUND

Wireless devices are becoming widely prevalent and are increasingly using wireless channels. The 3rd Generation Partnership Program (3GPP) is developing one or more standards for wireless communications.

### BRIEF DESCRIPTION OF THE DRAWINGS

FIG. 1 is an example schematic of user plane interfaces in wireless communications, in accordance with one or more example embodiments of the present disclosure.

FIG. 2 is an example schematic arrangement for network function performance measurement generation, in accordance with one or more embodiments of the present disclosure.

FIG. 3 shows example service producer implementations, in accordance with one or more embodiments of the present disclosure.

FIG. 4 depicts an example network architecture, in accordance with one or more example embodiments of the present disclosure.

FIG. 5 schematically illustrates a wireless network, in accordance with one or more example embodiments of the present disclosure.

FIG. 6 illustrates components capable of reading instructions from a machine-readable or computer-readable medium, in accordance with one or more example embodiments of the present disclosure.

FIG. 7 illustrates an example cellular network, in accordance with one or more example embodiments of the present disclosure.

FIG. 8 shows example network deployments including an example next generation fronthaul (NGF) deployment, in accordance with one or more example embodiments of the present disclosure.

FIG. 9 depicts an example of management services (MnS) deployment, in accordance with one or more example embodiments of the present disclosure.

FIG. 10 shows an example framework of provisioning MnS, in accordance with one or more example embodiments of the present disclosure.

FIG. 11 depicts an example AI/ML-assisted communication network, in accordance with one or more embodiments of the present disclosure.

FIG. 12 illustrates an example neural network, in accordance with one or more embodiments.

FIG. 13 shows an RL architecture, in accordance with one or more embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wireless devices may operate as defined by technical standards. For cellular telecommunications, the 3rd Generation Partnership Program (3GPP) defines communication techniques, including for performance measurements related to packet delays. In 3GPP, a protocol data unit (PDU) session anchor (PSA) is a term for the user plane function (UPF), which terminates the N6 interface of a PDU session within a 5G core network.

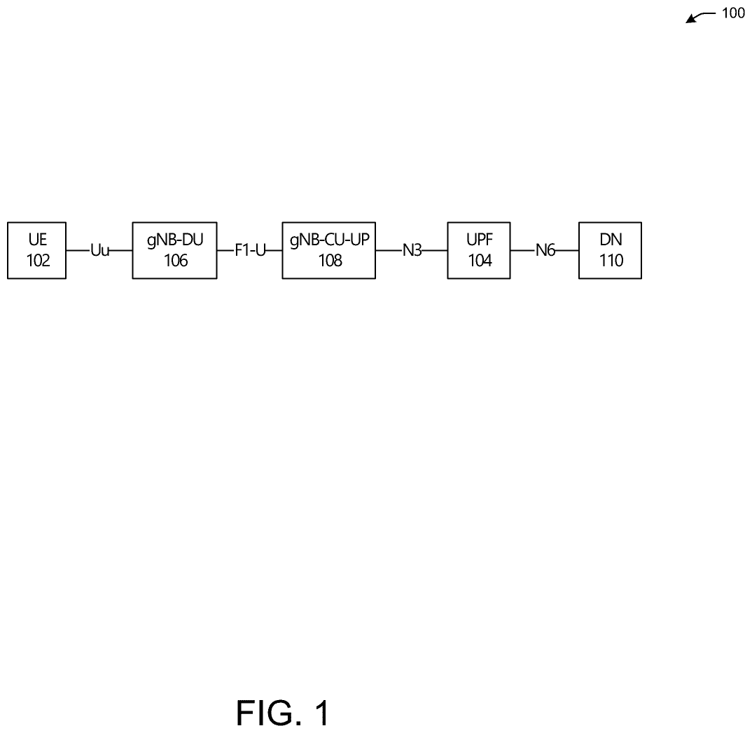

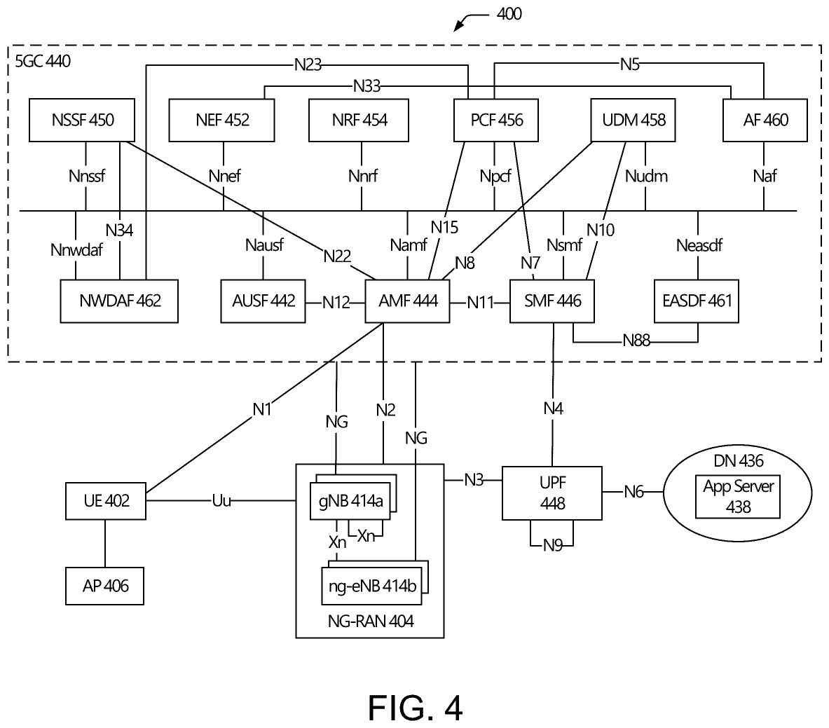

The end-to-end (e2e) downlink (DL) and/or uplink (UL) delay in fifth generation (5G) networks between a UE (e.g., UE 402 in FIGS. 1 and 4) and PSA UPF (e.g., UPF 448 in FIGS. 1 and 4) has direct impact to users' experience for some types of services (e.g., ultra reliable low latency communication (URLLC)). In case the PSA UPF 448 and NG-RAN (e.g., RAN 404 in FIG. 4) are time synchronised, the DL/UL delay between a PSA UPF 448 and a UE 402 can be measured at the PSA UPF 448.

For UL specifically, the UL packet delay in an NG-RAN may be measured by a gNB (e.g., gNB 414a in FIG. 4) with or without D1 UL PDCP delay occurred in the UE included (see e.g., [TS38415]). Therefore, separate measurements are needed to monitor the integrated UL packet delay between PSA UPF and UE for the cases of including and excluding D1 respectively.

The measurements on the DL/UL delay between PSA UPF 448 and NE (or UE 402) can be used to evaluate the user plane delay performance in 5G networks and users' experience.

The existing measurements for UL packet delay between PSA UPF 448 and UE 402 defined in clauses 5.4.9.2.1 and 5.4.9.2.2 in [TS28552] are not clear about whether D1 UL PDCP delay occurred in the UE 402 is included or not.

According to various embodiments, performance measurements related to user plane UL packet delay between PSA UPF 448 and UE 402 are generated with clear distinction about whether D1 UL PDCP delay occurred in the UE 402 included is included. The performance measurements related to user plane packet delay reflect the users' experience and can be used for optimizing the delay performance of the network, when necessary. This may be used to realize improved resource consumption efficiencies.

The present disclosure provides for generating performance measurements related to user plane UL packet delay between PSA UPF and UE, with clear distinction about whether D1 UL PDCP (packet data convergence protocol) delay occurred in the UE.

The performance measurements related to user plane packet delay reflect the users' experience and be used for optimizing the delay performance when necessary.

In some embodiments for NF performance measurement generation, a service producer collects raw performance measurements from respective NFs, and then generates performance measurements for NFs for its consumers.

In the present disclosure, at least one of the NEs is a UPF 448, and the service producer may be implemented within the same NF, a different NF, or in a separate management system.

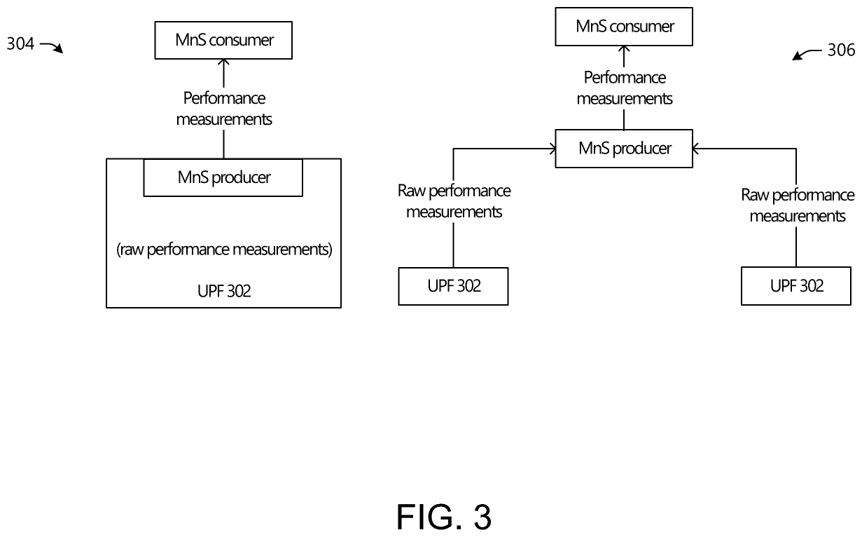

The following performance measurements can be collected by a management service (MnS) consumer from a MnS producer (see e.g., FIGS. 3 and 9-10). The following performance definitions can be added to [TS28552] (e.g., clauses 5.4.9.2.1 and 5.4.9.2.2) and are based on the template specified in 3GPP TS 32.404 v17.0.0 (2022 Apr. 1).

(1) UL delay between PSA UPF and UE.

(1) (A) Average UL packet delay between PSA UPF and UE.

Measurement Description: This measurement provides the average UL packet delay between PSA UPF 448 and UE. This measurement is split into subcounters per S-NSSAI. This measurement is only applicable to the case the PSA UPF 448 and NG-RAN 404 are time synchronized.

Collection Method: discrete event registration (DER) (n=1).

Condition(s): The measurement is obtained by the following method:

The UPF 448 performs QoS monitoring per the request received from SMF during PDU Session Establishment or Modification procedure.

In some examples, the UPF 448 may sample the GTP packets for QoS monitoring, the specific sampling rate is up to implementation.

For each received GTP PDU monitoring response packet (packet i) for QoS monitoring, the PSA UPF 448 records the following time stamps and information (see e.g., [TS23501] and [TS38415]):
T3 received in the GTP-U header of the monitoring response packet indicating the local time that the monitoring response packet was sent by the NG-RAN 404;
T4 that the monitoring response packet was received by the PSA UPF 448;
the UL Delay Result from UE 402 to NG-RAN 404 indicating the uplink delay measurement result which is the sum of the delay incurred in NG-RAN 404 (including the delay at gNB-CU-UP, on F1-U and on gNB-DU) and the delay over Uu interface (see e.g., [TS38415], and the UL Delay Result is denoted by DRul herein and/or in [TS28552]); and
the S-NSSAI associated to the GTP PDU monitoring response packet.

The PSA UPF 448 counts the number (N) of GTP PDU monitoring response packets for each S-NSSAI, and takes the following calculation for each S-NSSAI:

$$\frac{{\sum }_{i = 1}^{N} ( T {4}_{i} - T {3}_{i} + {DRul}_{i} )}{N}$$

Measurement Result (measured value(s), Units): Each measurement is a real representing the average delay in 0.1 ms.

Measurement Type: GTP.DelayUlPsaUpfUeMean.SNSSAI, where SNSSAI identifies the S-NSSAI;

Measurement Object Class: EP_N3 (contained by UPFFunction); and EP_N9 (contained by UPFFunction).

Switching Technology: Valid for packet switched traffic.

Generation: 5GS.

(1) (B) Distribution of UL Packet Delay between PSA UPF and UE.

Description: This measurement provides the distribution of UL packet delay between PSA UPF 448 and UE. This measurement is split into subcounters per S-NSSAI. This measurement is only applicable to the case the PSA UPF 448 and NG-RAN 404 are time synchronised.

b) Collection Method: DER (n=1).

c) Condition: The measurement is obtained by the following method:

The UPF 448 performs QoS monitoring per the request received from SMF during PDU Session Establishment or Modification procedure.

In some examples, the UPF 448 may sample the GTP packets for QoS monitoring, the specific sampling rate is up to implementation.

For each received GTP PDU monitoring response packet (packet i) for QoS monitoring, the PSA UPF 448 records the following time stamps and information (see e.g., [TS23501] and [TS38415]):
T3 received in the GTP-U header of the monitoring response packet indicating the local time that the monitoring response packet was sent by the NG-RAN 404;
T4 that the monitoring response packet was received by the PSA UPF 448;
The UL Delay Result from UE 402 to NG-RAN 404 indicating the uplink delay measurement result which is the sum of the delay incurred in NG-RAN 404 (including the delay at gNB-CU-UP, on F1-U and on gNB-DU) and the delay over Uu interface (see e.g., [TS38415], and the UL Delay Result is denoted by DRul herein and/or in [TS28552]); and
The S-NSSAI associated to the GTP PDU monitoring response packet.

The PSA UPF 448 1) takes the following calculation for each GTP PDU monitoring response packet (packet i) for each S-NSSAI, and 2) increment the corresponding bin with the delay range where the result of 1) falls into by 1 for the subcounter per S-NSSAI.

$$T {4}_{i} - T {3}_{i} + {DRul}_{i}$$

Measurement Result (measured value(s), Units): Each measurement is an integer representing the number of GTP PDUs measured with the delay within the range of the bin.

Measurement Type: GTP.DelayUlPsaUpfUeDist.SNSSAI.bin, where Bin indicates a delay range which is vendor specific, and SNSSAI identifies the S-NSSAI.

Measurement Object Class: EP_N3 (contained by UPFFunction); and EP_N9 (contained by UPFFunction).

Switching Technology: Valid for packet switched traffic.

Generation: 5GS.

(1) (C) Average UL packet delay between PSA UPF and UE (including D1).

Description: This measurement provides the average UL packet delay between PSA UPF 448 and UE, including the D1 UL PDCP delay occurred in the UE. This measurement is split into subcounters per S-NSSAI. This measurement is only applicable to the case the PSA UPF 448 and NG-RAN 404 are time synchronised.

Collection Method: DER (n=1).

Condition(s): The measurement is obtained by the following method:

The UPF 448 performs QoS monitoring per the request received from SMF during PDU Session Establishment or Modification procedure.

In some examples, the UPF 448 may sample the GTP packets for QoS monitoring, the specific sampling rate is up to implementation.

For each received GTP PDU monitoring response packet (packet i) for QoS monitoring, the PSA UPF 448 records the following time stamps and information (see e.g., [TS23501] and [TS38415]):
T3 received in the GTP-U header of the monitoring response packet indicating the local time that the monitoring response packet was sent by the NG-RAN 404;
T4 that the monitoring response packet was received by the PSA UPF 448;
The UL Delay Result from UE 402 to NG-RAN 404 indicating the uplink delay measurement result which is the sum of the delay incurred in NG-RAN 404 (including the delay at gNB-CU-UP, on F1-U and on gNB-DU) and the delay over Uu interface, and the D1 UL PDCP delay occurred in the UE 402 (see e.g., [TS38415], the UL Delay Result is denoted by DRul herein and/or in [TS28552]);
The S-NSSAI associated to the GTP PDU monitoring response packet.

The PSA UPF 448 counts the number (N) of GTP PDU monitoring response packets for each S-NSSAI, and takes the following calculation for each S-NSSAI:

$$\frac{{\sum }_{i = 1}^{N} ( T {4}_{i} - T {3}_{i} + {DRul}_{i} )}{N}$$

Measurement Result (measured value(s), Units): Each measurement is a real representing the average delay in 0.1 ms.

Measurement Type: GTP.DelayUlPsaUpfUeIncDIMean.SNSSAI, where SNSSAI identifies the S-NSSAI;

Measurement Object Class: EP_N3 (contained by UPFFunction); and EP_N9 (contained by UPFFunction).

Switching Technology: Valid for packet switched traffic.

Generation: 5GS.

(1) (D) Distribution of UL packet delay between PSA UPF and UE (including D1).

Description: This measurement provides the distribution of UL packet delay between PSA UPF 448 and UE, including the D1 UL PDCP delay occurred in the UE. This measurement is split into subcounters per S-NSSAI. This measurement is only applicable to the case the PSA UPF 448 and NG-RAN 404 are time synchronised.

Collection Method: DER (n=1).

Condition(s): The measurement is obtained by the following method:

The UPF 448 performs QoS monitoring per the request received from SMF during PDU Session Establishment or Modification procedure.

In some examples, the UPF 448 may sample the GTP packets for QoS monitoring, the specific sampling rate is up to implementation.

For each received GTP PDU monitoring response packet (packet i) for QoS monitoring, the PSA UPF 448 records the following time stamps and information (see e.g., [TS23501] and [TS38415]):
T3 received in the GTP-U header of the monitoring response packet indicating the local time that the monitoring response packet was sent by the NG-RAN 404;
T4 that the monitoring response packet was received by the PSA UPF 448;
The UL Delay Result from UE 402 to NG-RAN 404 indicating the uplink delay measurement result which is the sum of the delay incurred in NG-RAN 404 (including the delay at gNB-CU-UP, on F1-U and on gNB-DU) and the delay over Uu interface, and the D1 UL PDCP delay occurred in the UE 402 (see e.g., [TS38415], the UL Delay Result is denoted by DRul herein and/or in [TS28552]);
The S-NSSAI associated to the GTP PDU monitoring response packet.

The PSA UPF 448 1) takes the following calculation for each GTP PDU monitoring response packet (packet i) for each S-NSSAI, and 2) increments the corresponding bin with the delay range where the result of 1) falls into by 1 for the subcounter per S-NSSAI.

$$T {4}_{i} - T {3}_{i} + {DRul}_{i}$$

Measurement Result (measured value(s), Units): Each measurement is an integer representing the number of GTP PDUs measured with the delay within the range of the bin.

Measurement Type: GTP.DelayUlPsaUpfUeIncDIDist.SNSSAI.bin, where Bin indicates a delay range which is vendor specific, and SNSSAI identifies the S-NSSAI.

Measurement Object Class: EP_N3 (contained by UPFFunction); and EP_N9 (contained by UPFFunction).

Switching Technology: Valid for packet switched traffic.

Generation: 5GS.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

FIG. 1 is an example schematic 100 of user plane interfaces in wireless communications, in accordance with one or more example embodiments of the present disclosure.

FIG. 1 shows an example of user plane (UP) interfaces between a UE 102 and UPF 104 (or PSA UPF 104). Here, an air interface (Uu) is between the UE 102 and gNB-DU 106, an F1 UP interface (F1-U) between the gNB-DU 106 and a gNB-CU-UP 108, an N3 interface between the gNB-CU-UP 108 and the UPF 104 (or PSA UPF 104), and an N6 interface between the UPF 104 (or PSA UPF 104) and a DN 110.

Packet delay includes RAN part of delay and CN part of delay.

The RAN part of DL packet delay measurement comprises: D1 (DL delay in over-the-air interface), referring to Average delay DL air-interface in [TS28552] § 5.1.1.1.1; D2 (DL delay on gNB-DU), referring to Average delay in RLC sublayer of gNB-DU in [TS28552] § 5.1.3.3.3; D3 (DL delay on F1-U), referring to Average delay on F1-U in [TS28552] § 5.1.3.3.2; and D4 (DL delay in CU-UP), referring to Average delay DL in CU-UP in [TS28552] § 5.1.3.3.1. The DL packet delay measurements (e.g., D1, D2, D3, and D4) may be measured per DRB per UE.

The RAN part (including UE 102) of UL packet delay measurement comprises: D1 (UL PDCP packet average delay, as defined in [TS38314] § 4.3.1.1); D2.1 (average over-the-air interface packet delay, as defined in [TS38314] § 4.2.1.2.2); D2.2 (average RLC packet delay, as defined in [TS38314] § 4.2.1.2.3); D2.3 (average delay UL on F1-U, it is measured using the same metric as the average delay DL on F1-U defined in [TS28552] § 5.1.3.3.2); and D2.4 (average PDCP re-ordering delay, as defined in [TS38314] § 4.2.1.2.4). The UL packet delay measurements (e.g., D1, D2.1, D2.2, D2.3, and D2.4) may be measured per DRB per UE. The unit of D1, D2.1, D2.2, D2.3, and D2.4 is 0.1 ms.

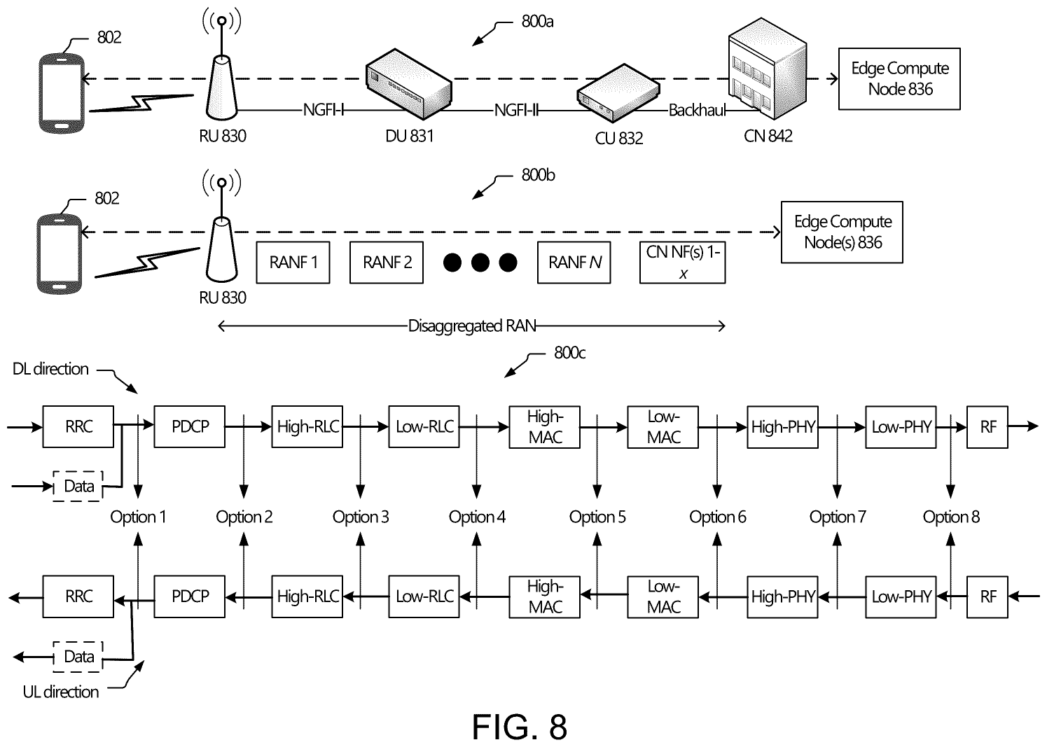

In some implementations, the RAN part of packet delay excludes the delay at F1-U interface (e.g., D2.3 and D3) for non CU-UP and DU split case (see e.g., FIG. 8). Additionally or alternatively, if the network (e.g., RAN 404 of FIG. 4) disables the PDCP re-ordering function, the value of Average PDCP re-ordering delay (e.g., D2.4) may be set to 0. Additionally or alternatively, for the QoS monitoring in [TS23501], the RAN 404 informs the RAN part of UL packet delay measurement, or the RAN part of DL packet delay measurement, or both to a CN.

With respect to D1 (UL PDCP Packet Average Delay per DRB per UE), the objective of this measurement performed by the UE 102 is to measure Packet Delay in the PDCP layer for QoS verification of MDT and/or for QoS monitoring as defined in [TS23501] and/or as discussed herein. The UL PDCP Packet Average Delay per DRB per UE is the PDCP Packet Delay in the UL direction per DRB. This measurement refers to PDCP queuing delay for DRBs in the UE 102, which captures the delay from packet arrival at PDCP upper SAP until the UL grant to transmit the packet is available, which has included the delay the UE gets resources granted (from sending SR/RACH to get the first grant).

In some examples, the UE 102 measures UL PDCP queueing delay at DRB level. It is up to gNB 414a to convert DRB level delay to QoS level delay with the assumption that all QoS flows mapped to the same DRB get the same QoS treatment, and it is up to gNB to calculate QoS level delay if multiple DRBs mapped with the same QoS.

The measurement is done separately per DRB. The UL PDCP Packet Average Delay per DRB per UE can be expressed as shown by Equation (1) below, with parameters shown by Table 1 below:

$$M ( T , drbid ) = \vert \frac{{\sum }_{∀ i} tDeliv ( i , drbid ) - tArrival ( i , drbid )}{I ( T )} \vert \qquad ( 1 )$$

TABLE 1
Parameter description for UL PDCP
Packet Average Delay per DRB per UE

| | |
|---|---|
| M(T, drbid) | PDCP average delay in the UL per DRB, |
| | averaged during time period T. Unit: 0.1 ms. |
| | PDCP average delay in the UL per DRB is 1 s if |
| | the actual value is larger than 1 s. |
| tArrival(i) | The point in time when the UL PDCP SDU i |
| | arrivals at PDCP upper SAP. |
| tDeliv(i) | The point in time when the UL MAC PDU k |
| | including the first part of UL PDCP SDU i is |
| | scheduled for transmission. |
| i | A UL PDCP SDU that is received by the PDCP |
| | during time period T. |
| I(T) | Total number of UL PDCP SDUs received during |
| | time period T. |
| T | Time Period during which the measurement is |
| | performed |
| drbid | The identity of the measured DRB. |

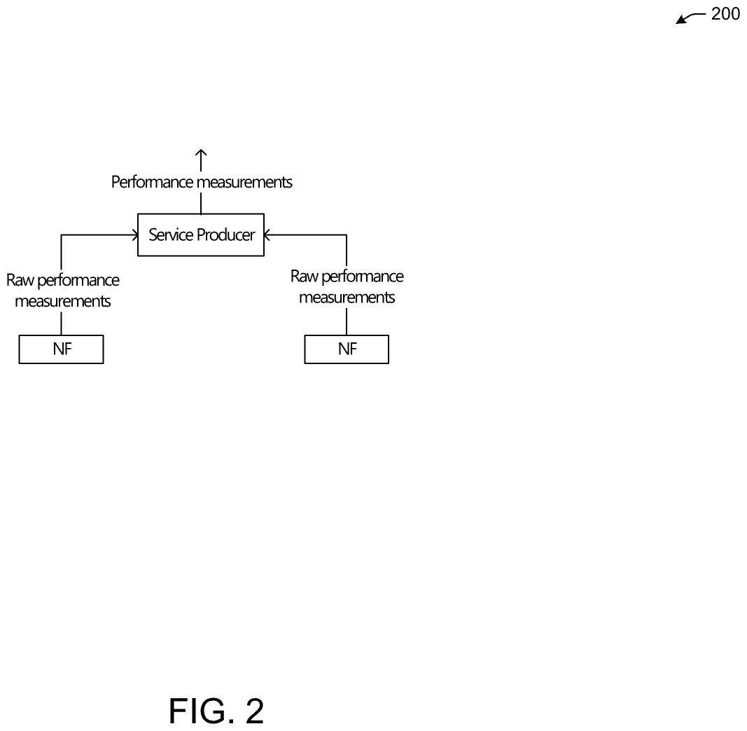

FIG. 2 is an example schematic arrangement 200 for network function performance measurement generation, in accordance with one or more embodiments of the present disclosure.

Here, a service producer collects raw performance measurements from respective NFs, and then generates performance measurements for NFs for its consumers.

FIG. 3 shows example service producer implementations, in accordance with one or more embodiments of the present disclosure.

In the present disclosure, at least one of the NFs is a UPF 302, and the service producer may be implemented within the same NF (implementation 304), a different NF, or in a separate management system (implementation 306).

FIG. 4 depicts an example network architecture 400. The network 400 may operate in a manner consistent with 3GPP technical specifications for LTE or 5G/NR systems. However, the example embodiments are not limited in this regard and the described examples may apply to other networks that benefit from the principles described herein, such as future 3GPP systems, or the like.

The network 400 includes a UE 402, which is any mobile or non-mobile computing device designed to communicate with a RAN 404 via an over-the-air connection. The UE 402 is communicatively coupled with the RAN 404 by a Uu interface, which may be applicable to both LTE and NR systems. Examples of the UE 402 include, but are not limited to, a smartphone, tablet computer, wearable device (e.g., smart watch, fitness tracker, smart glasses, smart clothing/fabrics, head-mounted displays, smart shows, and/or the like), desktop computer, workstation, laptop computer, in-vehicle infotainment system, in-car entertainment system, instrument cluster, head-up display (HUD) device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, machine-to-machine (M2M), device-to-device (D2D), machine-type communication (MTC) device, Internet of Things (IoT) device, smart appliance, flying drone or unmanned aerial vehicle (UAV), terrestrial drone or autonomous vehicle, robot, electronic signage, single-board computer (SBC) (e.g., Raspberry Pi, Arduino, Intel Edison, and the like), plug computers, and/or any type of computing device such as any of those discussed herein.

The network 400 may include a set of UEs 402 coupled directly with one another via a D2D, ProSc, PC5, and/or sidelink (SL) interface, and/or any other suitable interface such as any of those discussed herein. In 3GPP systems, SL communication involves communication between two or more UEs 402 using 3GPP technology without traversing a network node. These UEs 402 may be M2M/D2D/MTC/IoT devices and/or vehicular systems that communicate using an SL interface, which includes, for example, one or more SL logical channels (e.g., Sidelink Broadcast Control Channel (SBCCH), Sidelink Control Channel (SCCH), and Sidelink Traffic Channel (STCH)); one or more SL transport channels (e.g., Sidelink Shared Channel (SL-SCH) and Sidelink Broadcast Channel (SL-BCH)); and one or more SL physical channels (e.g., Physical Sidelink Shared Channel (PSSCH), Physical Sidelink Control Channel (PSCCH), Physical Sidelink Feedback Channel (PSFCH), Physical Sidelink Broadcast Channel (PSBCH), and/or the like). The UE 402 may perform blind decoding attempts of SL channels/links according to the various examples herein.

In some examples, the UE 402 may additionally communicate with an AP 406 via an over-the-air (OTA) connection. The AP 406 manages a WLAN connection, which may serve to offload some/all network traffic from the RAN 404. The connection between the UE 402 and the AP 406 may be consistent with any IEEE 802.11 protocol. Additionally, the UE 402, RAN 404, and AP 406 may utilize cellular-WLAN aggregation/integration (e.g., LWA/LWIP). Cellular-WLAN aggregation may involve the UE 402 being configured by the RAN 404 to utilize both cellular radio resources and WLAN resources.

The RAN 404 includes one or more access network nodes (ANs) 408. The ANs 408 terminate air-interface(s) for the UE 402 by providing access stratum protocols including RRC, PDCP, RLC, MAC, and PHY/L1 protocols. In this manner, the AN 408 enables data/voice connectivity between CN 420 and the UE 402. The ANs 408 may be a macrocell base station or a low power base station for providing femtocells, picocells or other like cells having smaller coverage areas, smaller user capacity, or higher bandwidth compared to macrocells; or some combination thereof. In these implementations, an AN 408 be referred to as a BS, gNB, RAN node, cNB, ng-cNB, NodeB, RSU, TRxP, and the like.

One example implementation is a “CU/DU split” architecture where the ANs 408 are embodied as a gNB-Central Unit (CU) that is communicatively coupled with one or more gNB-Distributed Units (DUs), where each DU may be communicatively coupled with one or more Radio Units (RUS) (also referred to as RRHs, RRUs, or the like). In some implementations, the one or more RUs may be individual RSUs. In some implementations, the CU/DU split may include an ng-eNB-CU and one or more ng-eNB-DUs instead of, or in addition to, the gNB-CU and gNB-DUs, respectively. The ANs 408 employed as the CU may be implemented in a discrete device or as one or more software entities running on server computers as part of, for example, a virtual network including a virtual Base Band Unit (BBU) or BBU pool, cloud RAN (CRAN), Radio Equipment Controller (REC), Radio Cloud Center (RCC), centralized RAN (C-RAN), virtualized RAN (vRAN), and/or the like (although these terms may refer to different implementation concepts). Any other type of architectures, arrangements, and/or configurations can be used.

The set of ANs 408 are coupled with one another via respective X2 interfaces if the RAN 404 is an LTE RAN or Evolved Universal Terrestrial Radio Access Network (E-UTRAN) 410, or respective Xn interfaces if the RAN 404 is a NG-RAN 414. The X2/Xn interfaces, which may be separated into control/user plane interfaces in some examples, may allow the ANs to communicate information related to handovers, data/context transfers, mobility, load management, interference coordination, and the like.

The ANs of the RAN 404 may each manage one or more cells, cell groups, component carriers, and the like to provide the UE 402 with an air interface for network access. The UE 402 may be simultaneously connected with a set of cells provided by the same or different ANs 408 of the RAN 404. For example, the UE 402 and RAN 404 may use carrier aggregation to allow the UE 402 to connect with a set of component carriers, each corresponding to a Pcell or Scell. In dual connectivity scenarios, a first AN 408 may be a master node that provides an MCG and a second AN 408 may be secondary node that provides an SCG. The first/second ANs 408 may be any combination of cNB, gNB, ng-eNB, and the like.

The RAN 404 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

Additionally or alternatively, individual UEs 402 provide radio information to one or more ANs 408 and/or one or more edge compute nodes (e.g., edge servers/hosts, and the like).

The UE 402 can also perform determine reference signal (RS) measurement and reporting procedures to provide the network with information about the quality of one or more wireless channels and/or the communication media in general, and this information can be used to optimize various aspects of the communication system.

In any of the examples discussed herein, any suitable data collection and/or measurement mechanism(s) may be used to collect the observation data. For example, data marking (e.g., sequence numbering, and the like), packet tracing, signal measurement, data sampling, and/or timestamping techniques may be used to determine any of the aforementioned metrics/observations. The collection of data may be based on occurrence of events that trigger collection of the data. Additionally or alternatively, data collection may take place at the initiation or termination of an event. The data collection can be continuous, discontinuous, and/or have start and stop times. The data collection techniques/mechanisms may be specific to a HW configuration/implementation or non-HW-specific, or may be based on various software parameters (e.g., OS type and version, and the like). Various configurations may be used to define any of the aforementioned data collection parameters. Such configurations may be defined by suitable specifications/standards, such as 3GPP (e.g., [SA6Edge]), ETSI (e.g., [MEC]), O-RAN (e.g., [O-RAN]), Intel® Smart Edge Open (formerly OpenNESS) (e.g., [ISEO]), IETF (e.g., MAMS [RFC8743]), IEEE/WiFi (e.g., [IEEE80211], [WiM11], [IEEE16090], and the like), and/or any other like standards such as those discussed herein.

In V2X scenarios the UE 402 or AN 408 may be or act as a roadside unit (RSU), which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network. Furthermore, one or more V2X RATs may be employed, which allow V2X nodes to communicate directly with one another, with infrastructure equipment (e.g., AN 408), and/or other devices/nodes. In some implementations, at least two distinct V2X RATs may be used including WLAN V2X (W-V2X) RATs based on IEEE V2X technologies (e.g., DSRC for the U.S. and ITS-G5 for Europe) and cellular V2X (C-V2X) RATs based on 3GPP V2X technologies (e.g., LTE V2X, 5G/NR V2X, and beyond). In one example, the C-V2X RAT may utilize a C-V2X air interface and the WLAN V2X RAT may utilize an W-V2X air interface.

The W-V2X RATs include, for example, IEEE Guide for Wireless Access in Vehicular Environments (WAVE) Architecture, IEEE Standards Association, IEEE 1609.0-2019 (10 Apr. 2019) (“[IEEE16090]”), V2X Communications Message Set Dictionary, SAE Int'l (23 Jul. 2020) (“[J2735_202007]”), Intelligent Transport Systems in the 5 GHz frequency band (ITS-G5), the [IEEE80211p] (which is the layer 1 (L1) and layer 2 (L2) part of WAVE, DSRC, and ITS-G5), and/or IEEE Standard for Air Interface for Broadband Wireless Access Systems, IEEE Std 802.16-2017, pp. 1-2726 (2 Mar. 2018) (“[WiM11]”). The term “DSRC” refers to vehicular communications in the 5.9 GHz frequency band that is generally used in the United States, while “ITS-G5” refers to vehicular communications in the 5.9 GHz frequency band in Europe. Since any number of different RATs are applicable (including [IEEE80211p] RATs) that may be used in any geographic or political region, the terms “DSRC” (used, among other regions, in the U.S) and “ITS-G5” (used, among other regions, in Europe) may be used interchangeably throughout this disclosure. The access layer for the ITS-G5 interface is outlined in ETSI EN 302 663 V1.3.1 (2020-01) (hereinafter “[EN302663]”) and describes the access layer of the ITS-S reference architecture. The ITS-G5 access layer comprises [IEEE80211] (which now incorporates [IEEE80211p]), as well as features for Decentralized Congestion Control (DCC) methods discussed in ETSI TS 102 687 V1.2.1 (2018-04) (“[TS102687]”). The access layer for 3GPP LTE-V2X based interface(s) is outlined in, inter alia, ETSI EN 303 613 V1.1.1 (2020-01), 3GPP TS 23.285 v16.2.0 (2019-12); and 3GPP 5G/NR-V2X is outlined in, inter alia, 3GPP TR 23.786 v16.1.0 (2019-06) and 3GPP TS 23.287 v18.0.0 (2023 Mar. 31) (“[TS23287]”).

In examples where the RAN 404 is an E-UTRAN 410 with one or more eNBs 412, the E-UTRAN 410 provides an LTE air interface (Uu) with the parameters and characteristics at least as discussed in 3GPP TS 36.300 v17.2.0 (2022 Sep. 30) (“[TS36300]”). In examples where the RAN 704 is an next generation (NG)-RAN 414 with a set of gNBs 416. Each gNB 416 connects with 5G-enabled UEs 402 using a 5G-NR air interface (which may also be referred to as a Uu interface) with parameters and characteristics as discussed in [TS38300], among many other 3GPP standards. Where the NG-RAN 414 includes a set of ng-eNBs 418, the one or more ng-eNBs 418 connect with a UE 402 via the 5G Uu and/or LTE Uu interface. The gNBs 416 and the ng-eNBs 418 connect with the 5GC 440 through respective NG interfaces, which include an N2 interface, an N3 interface, and/or other interfaces. The gNB 416 and the ng-eNB 418 are connected with each other over an Xn interface. Additionally, individual gNBs 416 are connected to one another via respective Xn interfaces, and individual ng-eNBs 418 are connected to one another via respective Xn interfaces. In some examples, the NG interface may be split into two parts, an NG user plane (NG-U) interface, which carries traffic data between the nodes of the NG-RAN 414 and a UPF 448 (e.g., N3 interface), and an NG control plane (NG-C) interface, which is a signaling interface between the nodes of the NG-RAN 414 and an AMF 444 (e.g., N2 interface).

The NG-RAN 414 may provide a 5G-NR air interface (which may also be referred to as a Uu interface) with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHZ. The 5G-NR air interface may include an SSB that is an area of a downlink resource grid that includes PSS/SSS/PBCH.

The 5G-NR air interface may utilize BWPs for various purposes. For example, BWP can be used for dynamic adaptation of the SCS. For example, the UE 402 can be configured with multiple BWPs where each BWP configuration has a different SCS. When a BWP change is indicated to the UE 402, the SCS of the transmission is changed as well. Another use case example of BWP is related to power saving. In particular, multiple BWPs can be configured for the UE 402 with different amount of frequency resources (e.g., PRBs) to support data transmission under different traffic loading scenarios. A BWP containing a smaller number of PRBs can be used for data transmission with small traffic load while allowing power saving at the UE 402 and in some cases at the gNB 416. A BWP containing a larger number of PRBs can be used for scenarios with higher traffic load.

In some implementations, individual gNBs 416 can include a gNB-CU and a set of gNB-DUs. Additionally or alternatively, gNBs 416 can include one or more RUs. In these implementations, the gNB-CU may be connected to each gNB-DU via respective F1 interfaces. In case of network sharing with multiple cell ID broadcast(s), each cell identity associated with a subset of PLMNs corresponds to a gNB-DU and the gNB-CU it is connected to, share the same physical layer cell resources. For resiliency, a gNB-DU may be connected to multiple gNB-CUs by appropriate implementation. Additionally, a gNB-CU can be separated into gNB-CU control plane (gNB-CU-CP) and gNB-CU user plane (gNB-CU-UP) functions. The gNB-CU-CP is connected to a gNB-DU through an F1 control plane interface (F1-C), the gNB-CU-UP is connected to the gNB-DU through an F1 user plane interface (F1-U), and the gNB-CU-UP is connected to the gNB-CU-CP through an E1 interface. In some implementations, one gNB-DU is connected to only one gNB-CU-CP, and one gNB-CU-UP is connected to only one gNB-CU-CP. For resiliency, a gNB-DU and/or a gNB-CU-UP may be connected to multiple gNB-CU-CPs by appropriate implementation. One gNB-DU can be connected to multiple gNB-CU-UPs under the control of the same gNB-CU-CP, and one gNB-CU-UP can be connected to multiple DUs under the control of the same gNB-CU-CP. Data forwarding between gNB-CU-UPs during intra-gNB-CU-CP handover within a gNB may be supported by Xn-U.

Similarly, individual ng-eNBs 418 can include an ng-eNB-CU and a set of ng-eNB-DUs. In these implementations, the ng-eNB-CU and each ng-eNB-DU are connected to one another via respective W1 interface. An ng-eNB can include an ng-eNB-CU-CP, one or more ng-cNB-CU-UP(s), and one or more ng-eNB-DU(s). An ng-eNB-CU-CP and an ng-eNB-CU-UP is connected via the E1 interface. An ng-eNB-DU is connected to an ng-eNB-CU-CP via the W1-C interface, and to an ng-eNB-CU-UP via the W1-U interface. The general principle described herein w.r.t gNB aspects also applies to ng-eNB aspects and corresponding E1 and W1 interfaces, if not explicitly specified otherwise.

The node hosting user plane part of the PDCP protocol layer (e.g., gNB-CU, gNB-CU-UP, and for EN-DC, MeNB or SgNB depending on the bearer split) performs user inactivity monitoring and further informs its inactivity or (re) activation to the node having control plane connection towards the core network (e.g., over E1, X2, or the like). The node hosting the RLC protocol layer (e.g., gNB-DU) may perform user inactivity monitoring and further inform its inactivity or (re) activation to the node hosting the control plane (e.g., gNB-CU or gNB-CU-CP).

In these implementations, the NG-RAN 414, is layered into a Radio Network Layer (RNL) and a Transport Network Layer (TNL). The NG-RAN 414 architecture (e.g., the NG-RAN logical nodes and interfaces between them) is part of the RNL. For each NG-RAN interface (e.g., NG, Xn, F1, and the like) the related TNL protocol and the functionality are specified. The TNL provides services for user plane transport and/or signalling transport. In NG-Flex configurations, each NG-RAN node is connected to all AMFs 444 of AMF sets within an AMF region supporting at least one slice also supported by the NG-RAN node. The AMF Set and the AMF Region are defined in [TS23501].

The RAN 404 is communicatively coupled to CN 420 that includes network elements and/or network functions (NFs) to provide various functions to support data and telecommunications services to customers/subscribers (e.g., UE 402). The components of the CN 420 may be implemented in one physical node or separate physical nodes. In some examples, NFV may be utilized to virtualize any or all of the functions provided by the network elements of the CN 420 onto physical compute/storage resources in servers, switches, and the like. A logical instantiation of the CN 420 may be referred to as a network slice, and a logical instantiation of a portion of the CN 420 may be referred to as a network sub-slice.

In the example of FIG. 4, the CN 440 is a 5GC 440 including an Authentication Server Function (AUSF) 442, Access and Mobility Management Function (AMF) 444, Session Management Function (SMF) 446, User Plane Function (UPF) 448, Network Slice Selection Function (NSSF) 450, Network Exposure Function (NEF) 452, Network Repository Function (NRF) 454, Policy Control Function (PCF) 456, Unified Data Management (UDM) 458, Unified Data Repository (UDR), Application Function (AF) 460, and Network Data Analytics Function (NWDAF) 462 coupled with one another over various interfaces as shown. The NEs in the 5GC 440 are briefly introduced as follows.

The NWDAF 462 includes one or more of the following functionalities: support data collection from NFs and AFs 460; support data collection from OAM; NWDAF service registration and metadata exposure to NFs and AFs 460; support analytics information provisioning to NFs and AFs 460; support machine learning (ML) model training and provisioning to NWDAF(s) 462 (e.g., those containing analytics logical function). Some or all of the NWDAF functionalities can be supported in a single instance of an NWDAF 462. The NWDAF 462 also includes an analytics reporting capability, which comprises means that allow discovery of the type of analytics that can be consumed by an external party and/or the request for consumption of analytics information generated by the NWDAF 462.

The NWDAF 462 interacts with different entities for different purposes, such as one or more of the following: data collection based on subscription to events provided by AMF 444, SMF 446, PCF 456, UDM 458, NSACF, AF 460 (directly or via NEF 452) and OAM (not shown); analytics and data collection using the Data Collection Coordination Function (DCCF); retrieval of information from data repositories (e.g. UDR via UDM 458 for subscriber-related information); data collection of location information from LCS system; storage and retrieval of information from an Analytics Data Repository Function (ADRF); analytics and data collection from a Messaging Framework Adaptor Function (MFAF); retrieval of information about NFs (e.g. from NRF 454 for NF-related information); on-demand provision of analytics to consumers, as specified in clause 6 of [TS23288]; and/or provision of bulked data related to analytics ID(s). NWDAF discovery and selection procedures are discussed in clause 6.3.13 in [TS23501] and clause 5.2 of [TS23288].

A single instance or multiple instances of NWDAF 462 may be deployed in a PLMN.

If multiple NWDAF 462 instances are deployed, the architecture supports deploying the NWDAF 462 as a central NF, as a collection of distributed NFs, or as a combination of both. If multiple NWDAF 462 instances are deployed, an NWDAF 462 can act as an aggregate point (e.g., aggregator NWDAF 462) and collect analytics information from other NWDAFs 462, which may have different serving areas, to produce the aggregated analytics (e.g., per analytics ID), possibly with analytics generated by itself. When multiple NWDAFs 462 exist, not all of them need to be able to provide the same type of analytics results. For example, some of the NWDAFs 462 can be specialized in providing certain types of analytics. An analytics ID information element is used to identify the type of supported analytics that NWDAF 462 can generate. In some implementations, NWDAF 462 instance(s) can be collocated with a 5GS NF. Additional aspects of NWDAF 462 functionality are defined in 3GPP TS 23.288 v18.2.0 (2023 Jun. 21) (“[TS23288]”).

Different NWDAF 462 instances may be present in the 5GC 440, with possible specializations per type of analytics. The capabilities of an NWDAF 462 instance are described in the NWDAF profile stored in the NRF 454. The NWDAF architecture allows for arranging multiple NWDAF 462 instances in a hierarchy/tree with a flexible number of layers/branches. The number and organisation of the hierarchy layers, as well as the capabilities of each NWDAF 462 instance remain deployment choices and may vary depending on implementation and/or use case. In a hierarchical deployment, NWDAFs 462 may provide data collection exposure capability for generating analytics based on the data collected by other NWDAFs 462, when DCCFs 463 and/or MFAFs 465 are not present in the network.

The AUSF 442 stores data for authentication of UE 402 and handle authentication-related functionality. The AUSF 442 may facilitate a common authentication framework for various access types.

The AMF 444 allows other functions of the 5GC 440 to communicate with the UE 402 and the RAN 404 and to subscribe to notifications about mobility events w.r.t the UE 402. The AMF 444 is also responsible for registration management (e.g., for registering UE 402), connection management, reachability management, mobility management, lawful interception of AMF-related events, and access authentication and authorization. The AMF 444 provides transport for SM messages between the UE 402 and the SMF 446, and acts as a transparent proxy for routing SM messages. AMF 444 also provides transport for SMS messages between UE 402 and an SMSF. AMF 444 interacts with the AUSF 442 and the UE 402 to perform various security anchor and context management functions. Furthermore, AMF 444 is a termination point of a RAN-CP interface, which includes the N2 reference point between the RAN 404 and the AMF 444. The AMF 444 is also a termination point of NAS (N1) signaling, and performs NAS ciphering and integrity protection.

The AMF 444 also supports NAS signaling with the UE 402 over an N3IWF interface. The N3IWF provides access to untrusted entities. N3IWF may be a termination point for the N2 interface between the (R)AN 704 and the AMF 444 for the control plane, and may be a termination point for the N3 reference point between the (R)AN 404 and the 448 for the user plane. As such, the AMF 444 handles N2 signaling from the SMF 446 and the AMF 444 for PDU sessions and QoS, encapsulate/de-encapsulate packets for IPSec and N3 tunneling, marks N3 user-plane packets in the UL, and enforces QoS corresponding to N3 packet marking taking into account QoS requirements associated with such marking received over N2. N3IWF may also relay UL and DL control-plane NAS signaling between the UE 402 and AMF 444 via an N1 reference point between the UE 402 and the AMF 444, and relay UL and DL user-plane packets between the UE 402 and UPF 448. The N3IWF also provides mechanisms for IPsec tunnel establishment with the UE 402. The AMF 444 may exhibit an Namf service-based interface, and may be a termination point for an N14 reference point between two AMFs 444 and an N17 reference point between the AMF 444 and a 5G-EIR (not shown by FIG. 4). In addition to the functionality of the AMF 444 described herein, the AMF 444 may provide support for Network Slice restriction and Network Slice instance restriction based on NWDAF analytics.

The SMF 446 is responsible for SM (e.g., session establishment, tunnel management between UPF 448 and AN 408); UE IP address allocation and management (including optional authorization); selection and control of UP function; configuring traffic steering at UPF 448 to route traffic to proper destination; termination of interfaces toward policy control functions; controlling part of policy enforcement, charging, and QoS; lawful intercept (for SM events and interface to LI system); termination of SM parts of NAS messages; DL data notification; initiating AN specific SM information, sent via AMF 444 over N2 to AN 408; and determining SSC mode of a session. SM refers to management of a PDU session, and a PDU session or “session” refers to a PDU connectivity service that provides or enables the exchange of PDUs between the UE 402 and the DN 436. The SMF 446 may also include the following functionalities to support edge computing enhancements (see e.g., [TS23548]): selection of EASDF 461 and provision of its address to the UE as the DNS server for the PDU session; usage of EASDF 461 services as defined in [TS23548]; and for supporting the application layer architecture defined in [TS23558], provision and updates of ECS address configuration information to the UE. Discovery and selection procedures for EASDFs 461 is discussed in [TS23501] § 6.3.23.

The UPF 448 acts as an anchor point for intra-RAT and inter-RAT mobility, an external PDU session point of interconnect to data network 436, and a branching point to support multi-homed PDU session. The UPF 448 also performs packet routing and forwarding, packet inspection, enforces user plane part of policy rules, lawfully intercept packets (UP collection), performs traffic usage reporting, perform QoS handling for a user plane (e.g., packet filtering, gating, UL/DL rate enforcement), performs UL traffic verification (e.g., SDF-to-QoS flow mapping), transport level packet marking in the UL and DL, and performs DL packet buffering and DL data notification triggering. UPF 448 may include an UL classifier to support routing traffic flows to a data network.

The NSSF 450 selects a set of network slice instances serving the UE 402. The NSSF 450 also determines allowed NSSAI and the mapping to the subscribed S-NSSAIs, if needed. The NSSF 450 also determines an AMF set to be used to serve the UE 402, or a list of candidate AMFs 444 based on a suitable configuration and possibly by querying the NRF 454. The selection of a set of network slice instances for the UE 402 may be triggered by the AMF 444 with which the UE 402 is registered by interacting with the NSSF 750; this may lead to a change of AMF 444. The NSSF 450 interacts with the AMF 444 via an N22 reference point; and may communicate with another NSSF in a visited network via an N31 reference point (not shown).

The NEF 452 securely exposes services and capabilities provided by 3GPP NFs for third party, internal exposure/re-exposure, AFs 460, edge computing networks/frameworks, and the like. In such examples, the NEF 452 may authenticate, authorize, or throttle the AFs 460. The NEF 452 stores/retrieves information as structured data using the Nudr interface to a Unified Data Repository (UDR). The NEF 452 also translates information exchanged with the AF 460 and information exchanged with internal NFs. For example, the NEF 452 may translate between an AF-Service-Identifier and an internal 5GC information, such as DNN, S-NSSAI, as described in clause 5.6.7 of [TS23501]. In particular, the NEF 452 handles masking of network and user sensitive information to external AF's 460 according to the network policy. The NEF 452 also receives information from other NFs based on exposed capabilities of other NFs. This information may be stored at the NEF 452 as structured data, or at a data storage NF using standardized interfaces. The stored information can then be re-exposed by the NEF 452 to other NFs and AFs, or used for other purposes such as analytics. For example, NWDAF analytics may be securely exposed by the NEF 452 for external party, as specified in [TS23288]. Furthermore, data provided by an external party may be collected by the NWDAF 462 via the NEF 452 for analytics generation purpose. The NEF 452 handles and forwards requests and notifications between the NWDAF 462 and AF(s) 460, as specified in [TS23288].

The NRF 454 supports service discovery functions, receives NF discovery requests from NF instances, and provides information of the discovered NF instances to the requesting NF instances. The NRF 454 also maintains NF profiles of available NF instances and their supported services.

For NWDAF 462, the NF profile includes: supported analytics ID(s), possibly per service, NWDAF serving area information (e.g., a list of TAIs for which the NWDAF can provide services and/or data), Supported Analytics Delay per Analytics ID (if available), NF types of the NF data sources, NF Set IDs of the NF data sources, if available, analytics aggregation capability (if available), analytics metadata provisioning capability (if available), ML model filter information parameters S-NSSAI(s) and area(s) of interest for the trained ML model(s) per analytics ID(s) (if available), federated learning (FL) capability type (e.g., FL server or FL client, if available), Time interval supporting FL (if available). The NWDAF's 462 Serving Arca information is common to all its supported analytics IDs. The analytics IDs supported by the NWDAF 462 may be associated with a supported analytics delay, for example, the analytics report can be generated with a time (including data collection delay and inference delay) in less than or equal to the supported analytics delay. The determination of supported analytics delay, and how the NWDAF 462 avoid updating its Supported Analytics Delay in NRF frequently may be NWDAF-implementation specific.

The PCF 456 provides policy rules to control plane functions to enforce them, and may also support unified policy framework to govern network behavior. The PCF 456 may also implement a front end to access subscription information relevant for policy decisions in a UDR 459 of the UDM 458. In addition to communicating with functions over reference points as shown, the PCF 456 exhibit an Npcf service-based interface.

The UDM 458 handles subscription-related information to support the network entities' handling of communication sessions, and stores subscription data of UE 402. For example, subscription data may be communicated via an N8 reference point between the UDM 458 and the AMF 444. The UDM 458 may include two parts, an application front end and a UDR. The UDR may store subscription data and policy data for the UDM 458 and the PCF 456, and/or structured data for exposure and application data (including PFDs for application detection, application request information for multiple UEs 402) for the NEF 452. The Nudr service-based interface may be exhibited by the UDR to allow the UDM 458, PCF 456, and NEF 452 to access a particular sct of the stored data, as well as to read, update (e.g., add, modify), delete, and subscribe to notification of relevant data changes in the UDR. The UDM 458 may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 458 may exhibit the Nudm service-based interface.

Edge Application Server Discovery Function (EASDF) 461 exhibits an Neasdf service-based interface, and is connected to the SMF 446 via an N88 interface. One or multiple EASDF instances may be deployed within a PLMN, and interactions between 5GC NF(s) and the EASDF 461 take place within a PLMN. The EASDF 461 includes one or more of the following functionalities: registering to NRF 454 for EASDF 461 discovery and selection; handling the DNS messages according to the instruction from the SMF 446; and/or terminating DNS security, if used. Handling the DNS messages according to the instruction from the SMF 446 includes one or more of the following functionalities: receiving DNS message handling rules and/or BaselineDNSPattern from the SMF 446; exchanging DNS messages from/with the UE 402; forwarding DNS messages to C-DNS or L-DNS for DNS query; adding EDNS client subnet (ECS) option into DNS query for an FQDN; reporting to the SMF 446 the information related to the received DNS messages; and/or buffering/discarding DNS messages from the UE 402 or DNS Server. The EASDF has direct user plane connectivity (e.g., without any NAT) with the PSA UPF over N6 for the transmission of DNS signaling exchanged with the UE. The deployment of a NAT between EASDF 461 and PSA UPF 448 may or may not be supported. Additional aspects of the EASDF 461 are discussed in [TS23548].

AF 460 provides application influence on traffic routing, provide access to NEF 452, and interact with the policy framework for policy control. The AF 460 may influence UPF 448 (re) selection and traffic routing. Based on operator deployment, when AF 460 is considered to be a trusted entity, the network operator may permit AF 460 to interact directly with relevant NFs. In some implementations, the AF 460 is used for edge computing implementations.

An NF that needs to collect data from an AF 460 may subscribe/unsubscribe to notifications regarding data collected from an AF 460, either directly from the AF 460 or via NEF 452. The data collected from an AF 460 is used as input for analytics by the NWDAF 462. The details for the data collected from an AF 460 as well as interactions between NEF 452, AF 460 and NWDAF 462 are described in [TS23288].

The 5GC 440 may enable edge computing by selecting operator/3rd party services to be geographically close to a point that the UE 402 is attached to the network. This may reduce latency and load on the network. In edge computing implementations, the 5GC 440 may select a UPF 448 close to the UE 402 and execute traffic steering from the UPF 448 to DN 436 via the N6 interface. This may be based on the UE subscription data, UE location, and information provided by the AF 460, which allows the AF 460 to influence UPF (re) selection and traffic routing.

The data network (DN) 436 may represent various network operator services, Internet access, or third party services that may be provided by one or more servers including, for example, application (app)/content server 438. The DN 436 may be an operator external public, a private PDN, or an intra-operator packet data network, for example, for provision of IMS services. In this example, the app server 438 can be coupled to an IMS via an S-CSCF or the I-CSCF. In some implementations, the DN 436 may represent one or more local area DNs (LADNs), which are DNs 436 (or DN names (DNNs)) that is/are accessible by a UE 402 in one or more specific areas. Outside of these specific areas, the UE 402 is not able to access the LADN/DN 436.

Additionally or alternatively, the DN 436 may be an edge DN 436, which is a (local) DN that supports the architecture for enabling edge applications. In these examples, the app server 438 may represent the physical hardware systems/devices providing app server functionality and/or the application software resident in the cloud or at an edge compute node that performs server function(s). In some examples, the app/content server 438 provides an edge hosting environment that provides support required for Edge Application Server's execution.

In some examples, the 5GS can use one or more edge compute nodes to provide an interface and offload processing of wireless communication traffic. In these examples, the edge compute nodes may be included in, or co-located with one or more RANs 404 or RAN nodes 414. For example, the edge compute nodes can provide a connection between the RAN 704 and UPF 448 in the 5GC 440. The edge compute nodes can use one or more NFV instances instantiated on virtualization infrastructure within the edge compute nodes to process wireless connections to and from the RAN 414 and UPF 448.

In some implementations, the edge compute nodes provide a distributed computing environment for application and service hosting, and also provide storage and processing resources so that data and/or content can be processed in close proximity to subscribers (e.g., users of UEs 402) for faster response times. The edge compute nodes also support multitenancy run-time and hosting environment(s) for applications, including virtual appliance applications that may be delivered as packaged virtual machine (VM) images, middleware application and infrastructure services, content delivery services including content caching, mobile big data analytics, and computational offloading, among others. Computational offloading involves offloading computational tasks, workloads, applications, and/or services to the edge compute nodes from the UEs 402, CN 440, DN 436, and/or server(s) 438, or vice versa. For example, a device application or client application operating in a UE 402 may offload application tasks or workloads to one or more edge compute nodes. In another example, an edge compute node may offload application tasks or workloads to a set of UEs 402 (e.g., for distributed machine learning computation and/or the like).

The interfaces of the 5GC 440 include reference points and service-based interfaces. The reference points include: N1 (between the UE 402 and the AMF 444), N2 (between RAN 414 and AMF 444), N3 (between RAN 414 and UPF 448), N4 (between the SMF 446 and UPF 448), N5 (between PCF 456 and AF 460), N6 (between UPF 448 and DN 436), N7 (between SMF 446 and PCF 456), N8 (between UDM 458 and AMF 444), N9 (between two UPFs 448), N10 (between the UDM 458 and the SMF 446), N11 (between the AMF 444 and the SMF 446), N12 (between AUSF 442 and AMF 444), N13 (between AUSF 442 and UDM 458), N14 (between two AMFs 444; not shown), N15 (between PCF 456 and AMF 444 in case of a non-roaming scenario, or between the PCF 456 in a visited network and AMF 444 in case of a roaming scenario), N16 (between two SMFs 446; not shown), and N22 (between AMF 444 and NSSF 450). Other reference point representations not shown in FIG. 4 can also be used. The service-based representation of FIG. 4 represents NFs within the control plane that enable other authorized NFs to access their services. The service-based interfaces (SBIs) include: Namf (SBI exhibited by AMF 444), Nsmf (SBI exhibited by SMF 446), Nnef (SBI exhibited by NEF 452), Npcf (SBI exhibited by PCF 456), Nudm (SBI exhibited by the UDM 458), Naf (SBI exhibited by AF 460), Nnrf (SBI exhibited by NRF 454), Nnssf (SBI exhibited by NSSF 450), Nausf (SBI exhibited by AUSF 442). Other service-based interfaces (e.g., Nudr, N5g-eir, and Nudsf) not shown in FIG. 4 can also be used. In some examples, the NEF 452 can provide an interface to edge compute nodes 436, which can be used to process wireless connections with the RAN 414.

Although not shown by FIG. 4, the network 400 may also include NFs that are not shown such as, for example, UDR, Unstructured Data Storage Function (UDSF), Network Slice Admission Control Function (NSACF), Network Slice-specific and Stand-alone Non-Public Network (SNPN) Authentication and Authorization Function (NSSAAF), UE radio Capability Management Function (UCMF), 5G-Equipment Identity Register (5G-EIR), CHarging Function (CHF), Time Sensitive Networking (TSN) AF 460, Time Sensitive Communication and Time Synchronization Function (TSCTSF), Data Collection Coordination Function (DCCF), Analytics Data Repository Function (ADRF), Messaging Framework Adaptor Function (MFAF), Binding Support Function (BSF), Non-Seamless WLAN Offload Function (NSWOF), Service Communication Proxy (SCP), Security Edge Protection Proxy (SEPP), Non-3GPP InterWorking Function (N3IWF), Trusted Non-3GPP Gateway Function (TNGF), Wireline Access Gateway Function (W-AGF), and/or Trusted WLAN Interworking Function (TWIF) as discussed in [TS23501].

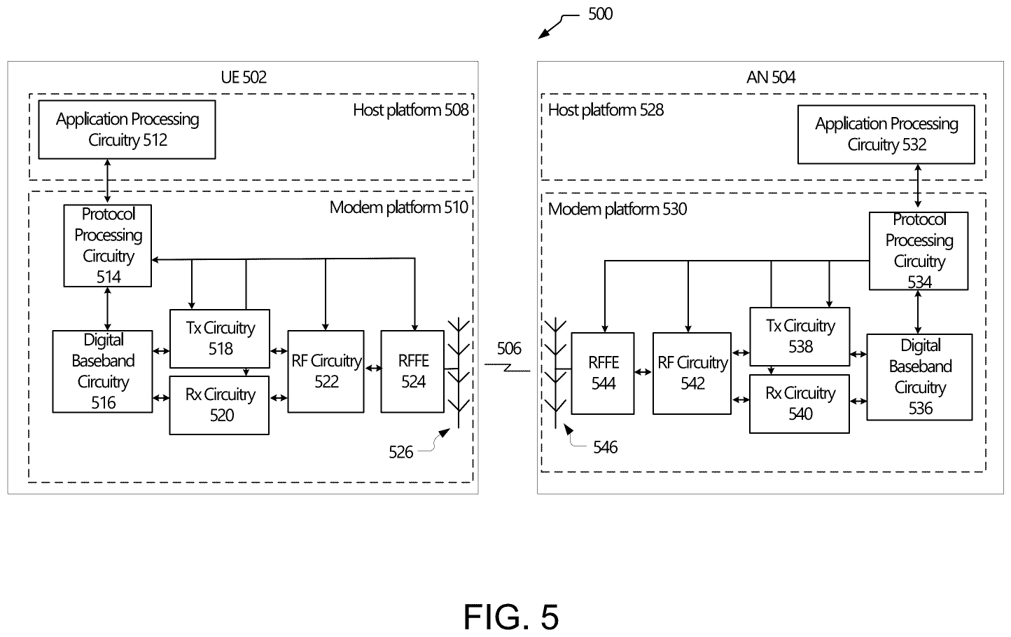

FIG. 5 schematically illustrates a wireless network 500. The wireless network 500 includes a UE 502 in wireless communication with an AN 504. The UE 502 and AN 504 may be similar to, and substantially interchangeable with, like-named components described elsewhere herein.

The UE 502 may be communicatively coupled with the AN 504 via connection 506. The connection 506 is illustrated as an air interface to enable communicative coupling, and can be consistent with cellular communications protocols such as an LTE protocol or a 5G NR protocol operating at mmWave or sub-6 GHZ frequencies.

The UE 502 includes a host platform 508 coupled with a modem platform 510. The host platform 508 includes application processing circuitry 512, which may be coupled with protocol processing circuitry 514 of the modem platform 510. The application processing circuitry 512 may run various applications for the UE 502 that source/sink application data. The application processing circuitry 512 may further implement one or more layer operations to transmit/receive application data to/from a data network. These layer operations includes transport (for example UDP) and Internet (for example, IP) operations.

The protocol processing circuitry 514 may implement one or more of layer operations to facilitate transmission or reception of data over the connection 506. The layer operations implemented by the protocol processing circuitry 514 includes, for example, MAC, RLC, PDCP, RRC and NAS operations.

The modem platform 510 may further include digital baseband circuitry 516 that may implement one or more layer operations that are “below” layer operations performed by the protocol processing circuitry 514 in a network protocol stack. These operations includes, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which includes one or more of space-time, space-frequency or spatial coding, reference signal generation/detection, preamble sequence generation and/or decoding, synchronization sequence generation/detection, control channel signal blind decoding, and other related functions.

The modem platform 510 may further include transmit circuitry 518, receive circuitry 520, RF circuitry 522, and RF front end (RFFE) 524, which includes or connect to one or more antenna panels 526. Briefly, the transmit circuitry 518 includes a digital-to-analog converter, mixer, intermediate frequency (IF) components, and/or the like; the receive circuitry 520 includes an analog-to-digital converter, mixer, IF components, and/or the like; the RF circuitry 522 includes a low-noise amplifier, a power amplifier, power tracking components, and/or the like; RFFE 524 includes filters (for example, surface/bulk acoustic wave filters), switches, antenna tuners, beamforming components (for example, phase-array antenna components), and/or the like. The selection and arrangement of the components of the transmit circuitry 518, receive circuitry 520, RF circuitry 522, RFFE 524, and antenna panels 526 (referred generically as “transmit/receive components”) may be specific to details of a specific implementation such as, for example, whether communication is TDM or FDM, in mm Wave or sub-6 gHz frequencies, and/or the like. In some examples, the transmit/receive components may be arranged in multiple parallel transmit/receive chains, may be disposed in the same or different chips/modules, and/or the like.

In some examples, the protocol processing circuitry 514 includes one or more instances of control circuitry (not shown) to provide control functions for the transmit/receive components.

A UE reception may be established by and via the antenna panels 526, RFFE 524, RF circuitry 522, receive circuitry 520, digital baseband circuitry 516, and protocol processing circuitry 514. In some examples, the antenna panels 526 may receive a transmission from the AN 504 by receive-beamforming signals received by a set of antennas/antenna elements of the one or more antenna panels 526.

A UE transmission may be established by and via the protocol processing circuitry 514, digital baseband circuitry 516, transmit circuitry 518, RF circuitry 522, RFFE 524, and antenna panels 526. In some examples, the transmit components of the UE 504 may apply a spatial filter to the data to be transmitted to form a transmit beam emitted by the antenna elements of the antenna panels 526.

Similar to the UE 502, the AN 504 includes a host platform 528 coupled with a modem platform 530. The host platform 528 includes application processing circuitry 532 coupled with protocol processing circuitry 534 of the modem platform 530. The modem platform may further include digital baseband circuitry 536, transmit circuitry 538, receive circuitry 540, RF circuitry 542, RFFE circuitry 544, and antenna panels 546. The components of the AN 504 may be similar to and substantially interchangeable with like-named components of the UE 502. In addition to performing data transmission/reception as described above, the components of the AN 508 may perform various logical functions that include, for example, RNC functions such as radio bearer management, uplink and downlink dynamic radio resource management, and data packet scheduling.

Examples of the antenna elements of the antenna panels 526 and/or the antenna elements of the antenna panels 546 include planar inverted-F antennas (PIFAs), monopole antennas, dipole antennas, loop antennas, patch antennas, Yagi antennas, parabolic dish antennas, omni-directional antennas, and/or the like.

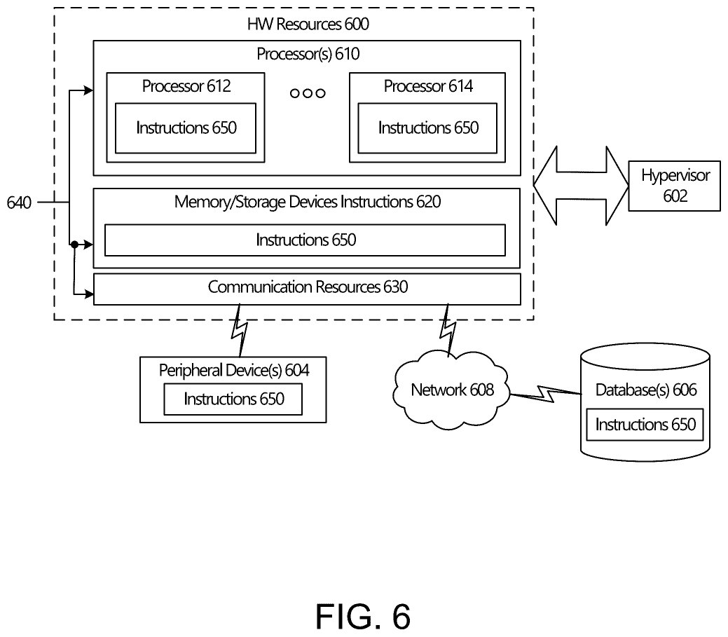

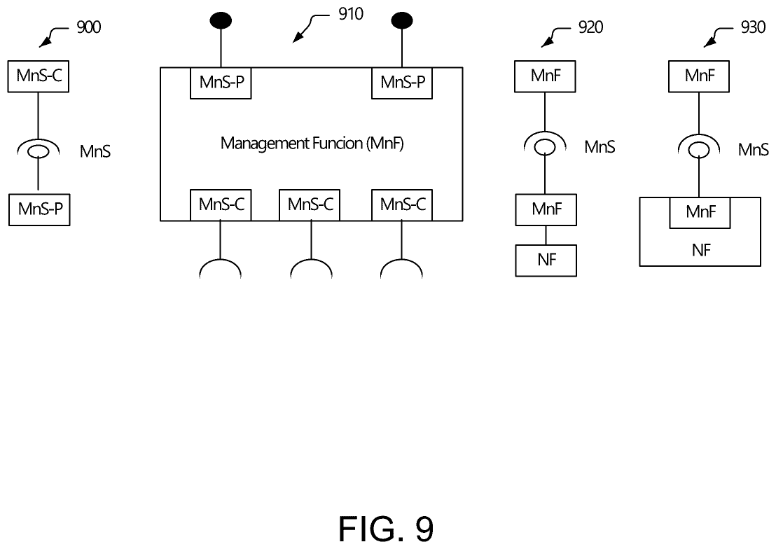

FIG. 6 illustrates components capable of reading instructions from a machine-readable or computer-readable medium (e.g., a non-transitory machine-readable storage medium) and perform any one or more of the methodologies discussed herein. Specifically, FIG. 9 shows hardware resources 600 including one or more processors (or processor cores) 610, one or more memory/storage devices 620, and one or more communication resources 630, each of which may be communicatively coupled via a bus 640 or other interface circuitry. For examples where node virtualization (e.g., NFV) is utilized, a hypervisor 602 may be executed to provide an execution environment for one or more network slices/sub-slices to utilize the hardware resources 600. In some examples, the hardware resources 600 may be implemented in or by an individual compute node, which may be housed in an enclosure of various form factors. In other examples, the hardware resources 600 may be implemented by multiple compute nodes that may be deployed in one or more data centers and/or distributed across one or more geographic regions.

The processors 610 may include, for example, a processor 612 and a processor 614. The processors 610 may be or include, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), a microprocessor or controller, a multi-core processor, a multithreaded processor, an ultra-low voltage processor, an embedded processor, an xPU, a data processing unit (DPU), an Infrastructure Processing Unit (IPU), a network processing unit (NPU), another processor (including any of those discussed herein), and/or any suitable combination thereof.

The memory/storage devices 620 may include main memory, disk storage, or any suitable combination thereof. The memory/storage devices 620 may include, but are not limited to, any type of volatile, non-volatile, semi-volatile memory, and/or any combination thereof. As examples, the memory/storage devices 620 can be or include random access memory (RAM), static RAM (SRAM), dynamic RAM (DRAM), synchronous DRAM (SDRAM), magnetoresistive RAM (MRAM), conductive bridge Random Access Memory (CB-RAM), spin transfer torque (STT)-MRAM, phase change RAM (PRAM), core memory, dual inline memory modules (DIMMs), microDIMMs, MiniDIMMs, block addressable memory device(s) (e.g., those based on NAND or NOR technologies (e.g., single-level cell (SLC), Multi-Level Cell (MLC), Quad-Level Cell (QLC), Tri-Level Cell (TLC), or some other NAND), read-only memory (ROM), programmable ROM (PROM), erasable PROM (EPROM), electrically EPROM (EEPROM), flash memory, non-volatile RAM (NVRAM), solid-state storage, magnetic disk storage mediums, optical storage mediums, memory devices that use chalcogenide glass, multi-threshold level NAND flash memory, NOR flash memory, single or multi-level Phase Change Memory (PCM) and/or phase change memory with a switch (PCMS), NVM devices that use chalcogenide phase change material (e.g., chalcogenide glass), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a th11istor based memory device, and/or a combination of any of the aforementioned memory devices, and/or other memory.

The communication resources 630 may include interconnection or network interface controllers, components, or other suitable devices to communicate with one or more peripheral devices 604 or one or more databases 606 or other network elements via a network 608. For example, the communication resources 630 may include wired communication components (e.g., for coupling via USB, Ethernet, and/or the like), cellular communication components, NFC components, Bluetooth® (or Bluetooth® Low Energy) components, Wi-Fi® components, and other communication components.

Instructions 650 comprise software, program code, application(s), applet(s), an app(s), firmware, microcode, machine code, and/or other executable code for causing at least any of the processors 610 to perform any one or more of the methodologies and/or techniques discussed herein. The instructions 650 may reside, completely or partially, within at least one of the processors 610 (e.g., within the processor's cache memory), the memory/storage devices 620, or any suitable combination thereof. Furthermore, any portion of the instructions 650 may be transferred to the hardware resources 600 from any combination of the peripheral devices 604 or the databases 606. Accordingly, the memory of processors 610, the memory/storage devices 620, the peripheral devices 604, and the databases 606 are examples of computer-readable and machine-readable media.

In some examples, the peripheral devices 604 may represent one or more sensors (also referred to as “sensor circuitry”). The sensor circuitry includes devices, modules, or subsystems whose purpose is to detect events or changes in its environment and send the information (sensor data) about the detected events to some other a device, module, subsystem, and/or the like. Individual sensors may be exteroceptive sensors (e.g., sensors that capture and/or measure environmental phenomena and/external states), proprioceptive sensors (e.g., sensors that capture and/or measure internal states of a compute node or platform and/or individual components of a compute node or platform), and/or exproprioceptive sensors (e.g., sensors that capture, measure, or correlate internal states and external states). Examples of such sensors include, inter alia, inertia measurement units (IMU) comprising accelerometers, glloscopes, and/or magnetometers; microelectromechanical systems (MEMS) or nanoelectromechanical systems (NEMS) comprising 3-11is accelerometers, 3-11is glloscopes, and/or magnetometers; level sensors; flow sensors; temperature sensors (e.g., thermistors, including sensors for measuring the temperature of internal components and sensors for measuring temperature external to the compute node or platform); pressure sensors; barometric pressure sensors; gravimeters; altimeters; image capture devices (e.g., cameras); light detection and ranging (LiDAR) sensors; proximity sensors (e.g., infrared radiation detector and the like); depth sensors, ambient light sensors; optical light sensors; ultrasonic transceivers; microphones; and the like.

Additionally or alternatively, the peripheral devices 604 may represent one or more actuators, which allow a compute node, platform, machine, device, mechanism, system, or other object to change its state, position, and/or orientation, or move or control a compute node, platform, machine, device, mechanism, system, or other object. The actuators comprise electrical and/or mechanical devices for moving or controlling a mechanism or system, and converts energy (e.g., electric current or moving air and/or liquid) into some kind of motion. As examples, the actuators can be or include any number and combination of the following: soft actuators (e.g., actuators that changes its shape in response to a stimuli such as, for example, mechanical, thermal, magnetic, and/or electrical stimuli), hydraulic actuators, pneumatic actuators, mechanical actuators, electromechanical actuators (EMAs), microelectromechanical actuators, electrohydraulic actuators, linear actuators, linear motors, rotary motors, DC motors, stepper motors, servomechanisms, electromechanical switches, electromechanical relays (EMRs), power switches, valve actuators, piezoelectric actuators and/or biomorphs, thermal biomorphs, solid state actuators, solid state relays (SSRs), shape-memory alloy-based actuators, electroactive polymer-based actuators, relay driver integrated circuits (ICs), solenoids, impactive actuators/mechanisms (e.g., jaws, claws, tweezers, clamps, hooks, mechanical fingers, humaniform dexterous robotic hands, and/or other gripper mechanisms that physically grasp by direct impact upon an object), propulsion actuators/mechanisms (e.g., wheels, 11les, thrusters, propellers, engines, motors (e.g., those discussed previously), clutches, and the like), projectile actuators/mechanisms (e.g., mechanisms that shoot or propel objects or elements), and/or audible sound generators, visual warning devices, and/or other like electromechanical components. Additionally or alternatively, the actuators can include virtual instrumentation and/or virtualized actuator devices. Additionally or alternatively, the actuators can include various controller and/or components of the compute node or platform (or components thereof) such as, for example, host controllers, cooling element controllers, baseboard management controller (BMC), platform controller hub (PCH), uncore components (e.g., shared last level cache (LLC) cache, caching agent (Cbo), integrated memory controller (IMC), home agent (HA), power control unit (PCU), configuration agent (Ubox), integrated I/O controller (IIO), and interconnect (IX) link interfaces and/or controllers), and/or any other components such as any of those discussed herein. The compute node or platform may be configured to operate one or more actuators based on one or more captured events, instructions, control signals, and/or configurations received from a service provider, client device, and/or other components of a compute node or platform. Additionally or alternatively, the actuators are used to change the operational state (e.g., on/off, zoom or focus, and/or the like), position, and/or orientation of the sensors.

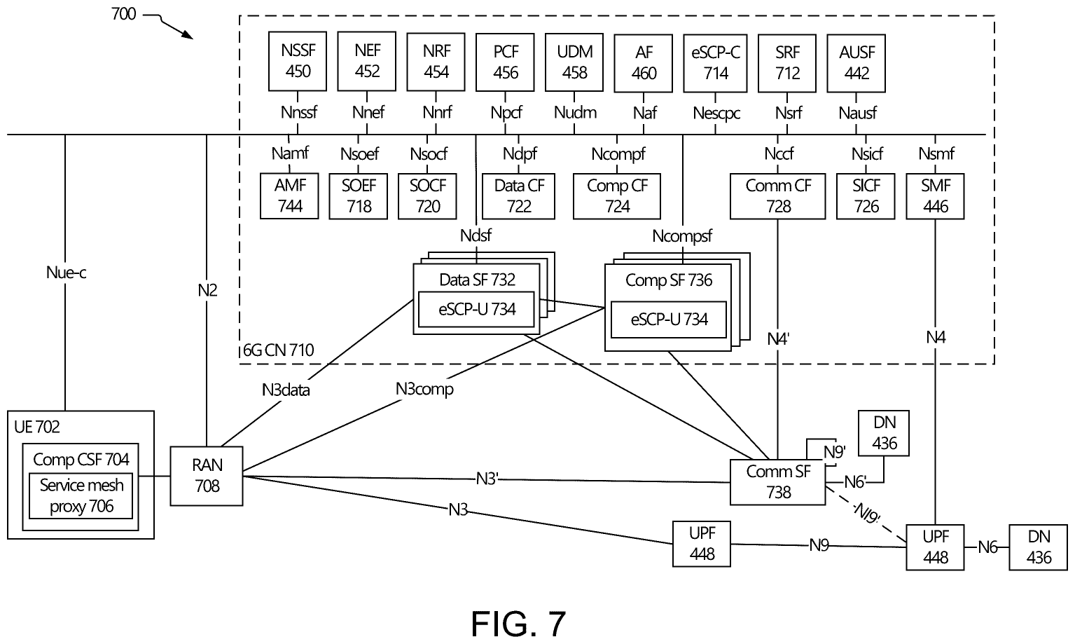

FIG. 7 illustrates an example cellular network 700, in accordance with one or more embodiments of the present disclosure.

The network 700 may operate in a matter consistent with 3GPP technical specifications or technical reports for 6G systems. In some examples, the network 700 may operate concurrently with network 400. For example, in some examples, the network 1000 may share one or more frequency or bandwidth resources with network 400. As one specific example, a UE (e.g., UE 1002) may be configured to operate in both network 700 and network 400. Such configuration may be based on a UE including circuitry configured for communication with frequency and bandwidth resources of both networks 400 and 700. In general, several elements of network 700 may share one or more characteristics with elements of network 400. For the sake of brevity and clarity, such elements may not be repeated in the description of network 700.

The network 700 may include a UE 702, which may include any mobile or non-mobile computing device designed to communicate with a RAN 708 via an over-the-air connection. The UE 702 may be similar to, for example, UE 402. The UE 702 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, and/or the like.

Although not specifically shown in FIG. 7, in some examples the network 700 may include a set of UEs coupled directly with one another via a sidelink interface. The UEs may be M2M/D2D devices that communicate using physical sidelink channels such as, but not limited to, PSBCH, PSDCH, PSSCH, PSCCH, PSFCH, and/or the like. Similarly, although not specifically shown in FIG. 7, the UE 702 may be communicatively coupled with an AP such as AP 406 as described with respect to FIG. 4. Additionally, although not specifically shown in FIG. 7, in some examples the RAN 708 may include one or more ANs such as AN 408 as described with respect to FIG. 4. The RAN 708 and/or the AN of the RAN 708 may be referred to as a base station (BS), a RAN node, or using some other term or name.

The UE 702 and the RAN 708 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHZ and above frequency ranges. Such frequency ranges may additionally or alternatively be referred to as “millimeter wave” or “mmWave” frequency ranges.

The RAN 708 may allow for communication between the UE 702 and a 6G core network (CN) 710. Specifically, the RAN 708 may facilitate the transmission and reception of data between the UE 702 and the 6G CN 710. The 6G CN 710 may include various functions such as NSSF 450, NEF 452, NRF 454, PCF 456, UDM 458, AF 460, SMF 446, and AUSF 442. The 6G CN 710 may additional include UPF 448 and DN 436 as shown in FIG. 7.

Additionally, the RAN 708 may include various additional functions that are in addition to, or alternative to, functions of a legacy cellular network such as a 4G or 5G network. Two such functions may include a Compute Control Function (Comp CF) 724 and a Compute Service Function (Comp SF) 736. The Comp CF 724 and the Comp SF 736 may be parts or functions of the Computing Service Plane. Comp CF 724 may be a control plane function that provides functionalities such as management of the Comp SF 736, computing task context generation and management (e.g., create, read, modify, delete), interaction with the underlaying computing infrastructure for computing resource management, and/or the like. Comp SF 736 may be a user plane function that serves as the gateway to interface computing service users (such as UE 702) and computing nodes behind a Comp SF instance. Some functionalities of the Comp SF 736 may include: parse computing service data received from users to compute tasks executable by computing nodes; hold service mesh ingress gateway or service API gateway; service and charging policies enforcement; performance monitoring and telemetry collection, and/or the like. In some examples, a Comp SF 736 instance may serve as the user plane gateway for a cluster of computing nodes. A Comp CF 724 instance may control one or more Comp SF 736 instances.

Two other such functions may include a Communication Control Function (Comm CF) 728 and a Communication Service Function (Comm SF) 738, which may be parts of the Communication Service Plane. The Comm CF 728 may be the control plane function for managing the Comm SF 738, communication sessions creation/configuration/releasing, and managing communication session context. The Comm SF 738 may be a user plane function for data transport. Comm CF 728 and Comm SF 738 may be considered as upgrades of SMF 446 and UPF 448, which were described with respect to a 5G system in FIG. 4. The upgrades provided by the Comm CF 728 and the Comm SF 738 may enable service-aware transport. For legacy (e.g., 4G or 5G) data transport, SMF 446 and UPF 448 may still be used.

Two other such functions may include a Data Control Function (Data CF) 722 and Data Service Function (Data SF) 732 may be parts of the Data Service Plane. Data CF 722 may be a control plane function and provides functionalities such as Data SF 732 management, Data service creation/configuration/releasing, Data service context management, and/or the like. Data SF 732 may be a user plane function and serve as the gateway between data service users (such as UE 702 and the various functions of the 6G CN 710) and data service endpoints behind the gateway. Specific functionalities may include: parse data service user data and forward to corresponding data service endpoints, generate charging data, report data service status.

Another such function may be the Service Orchestration and Chaining Function (SOCF) 720, which may discover, orchestrate and chain up communication/computing/data services provided by functions in the network. Upon receiving service requests from users, SOCF 720 may interact with one or more of Comp CF 724, Comm CF 728, and Data CF 722 to identify Comp SF 736, Comm SF 738, and Data SF 732 instances, configure service resources, and generate the service chain, which could contain multiple Comp SF 736, Comm SF 738, and Data SF 732 instances and their associated computing endpoints. Workload processing and data movement may then be conducted within the generated service chain. The SOCF 720 may also be responsible for maintaining, updating, and releasing a created service chain.

Another such function may be the service registration function (SRF) 712, which may act as a registry for system services provided in the user plane such as services provided by service endpoints behind Comp SF 736 and Data SF 732 gateways and services provided by the UE 702. The SRF 712 may be considered a counterpart of NRF 454, which may act as the registry for network functions.

Other such functions may include an evolved service communication proxy (eSCP) and service infrastructure control function (SICF) 726, which may provide service communication infrastructure for control plane services and user plane services. The eSCP may be related to the service communication proxy (SCP) of 5G with user plane service communication proxy capabilities being added. The eSCP is therefore expressed in two parts: cCSP-C 712 and eSCP-U 734, for control plane service communication proxy and user plane service communication proxy, respectively. The SICF 726 may control and configure eCSP instances in terms of service traffic routing policies, access rules, load balancing configurations, performance monitoring, and/or the like.

Another such function is the AMF 744. The AMF 744 may be similar to 444, but with additional functionality. Specifically, the AMF 744 may include potential functional repartition, such as move the message forwarding functionality from the AMF 744 to the RAN 1008.

Another such function is the service orchestration exposure function (SOEF) 718. The SOEF may be configured to expose service orchestration and chaining services to external users such as applications.

The UE 702 may include an additional function that is referred to as a computing client service function (comp CSF) 704. The comp CSF 704 may have both the control plane functionalities and user plane functionalities, and may interact with corresponding network side functions such as SOCF 720, Comp CF 724, Comp SF 736, Data CF 722, and/or Data SF 732 for service discovery, request/response, compute task workload exchange, and/or the like. The Comp CSF 704 may also work with network side functions to decide on whether a computing task should be run on the UE 702, the RAN 708, and/or an element of the 6G CN 710.

The UE 702 and/or the Comp CSF 704 may include a service mesh proxy 706. The service mesh proxy 706 may act as a proxy for service-to-service communication in the user plane. Capabilities of the service mesh proxy 706 may include one or more of addressing, security, load balancing, and/or the like.

FIG. 8 shows example network deployments including an example next generation fronthaul (NGF) deployment 800a where a user equipment (UE) 802 is connected to an RU 830 (also referred to as a “remote radio unit 830”, “a remote radio head 830”, or “RRH 830”) via an air interface, the RU 830 is connected to a Digital Unit (DU) 831 via a NGF interface (NGFI)-I, the DU 831 is connected to a Central Unit (CU) 832 via an NGFI-II, and the CU 832 is connected to a core network (CN) 842 via a backhaul interface. In 3GPP NG-RAN implementations (see e.g., [TS38401]), the DU 831 may be a distributed unit (for purposes of the present disclosure, the term “DU” may refer to a digital unit and/or a distributed unit unless the context dictates otherwise). The UEs 802 may be the same or similar to, and/or share one or more features with UE 402, UE 502, hardware resources 600, UE 702, UE 805, and/or any other UE described herein.

In some implementations, the NGF deployment 800a may be arranged in a distributed RAN (D-RAN) architecture where the CU 832, DU 831, and RU 830 reside at a cell site and the CN 842 is located at a centralized site. Alternatively, the NGF deployment 800a may be arranged in a centralized RAN (C-RAN) architecture with centralized processing of one or more baseband units (BBUs) at the centralized site. In C-RAN architectures, the radio components are split into discrete components, which can be located in different locations. In one example C-RAN implementation, only the RU 830 is disposed at the cell site, and the DU 831, the CU 832, and the CN 842 are centralized or disposed at a central location. In another example C-RAN implementation, the RU 830 and the DU 831 are located at the cell site, and the CU 832 and the CN 842 are at the centralized site. In another example C-RAN implementation, only the RU 830 is disposed at the cell site, the DU 831 and the CU 832 are located a RAN hub site, and the CN 842 is at the centralized site.

The CU 832 is a central controller that can serve or otherwise connect to one or multiple DUs 831 and/or multiple RUs 830. The CU 832 is network (logical) nodes hosting higher/upper layers of a network protocol functional split. For example, in the 3GPP NG-RAN and/or O-RAN architectures, a CU 832 hosts the radio resource control (RRC), Service Data Adaptation Protocol (SDAP), and/or Packet Data Convergence Protocol (PDCP) layers of a next generation NodeB (gNB), or hosts the RRC and PDCP protocol layers when included in or operating as an E-UTRA-NR gNB (en-gNB). The SDAP sublayer performs mapping between QoS flows and a data radio bearers (DRBs) and marking QoS flow IDs (QFI) in both DL and UL packets. The PDCP sublayer performs transfers user plane or control plane data; maintains PDCP sequence numbers (SNs); header compression and decompression using the Robust Header Compression (ROHC) and/or Ethernet Header Compression (EHC) protocols; ciphering and deciphering; integrity protection and integrity verification; provides timer based SDU discard; routing for split bearers; duplication and duplicate discarding; reordering and in-order delivery; and/or out-of-order delivery. In various implementations, a CU 1132 terminates respective F1 interfaces connected with corresponding DUs 831 (see e.g., [TS38401]).

A CU 832 may include a CU-control plane (CP) entity (referred to herein as “CU-CP 832”) and a CU-user plane (UP) entity (referred to herein as “CU-UP 832”). The CU-CP 832 is a logical node hosting the RRC layer and the control plane part of the PDCP protocol layer of the CU 832 (e.g., a gNB-CU for an en-gNB or a gNB). The CU-CP terminates an E1 interface connected with the CU-UP and the F1-C interface connected with a DU 831. The CU-UP 832 is a logical node hosting the user plane part of the PDCP protocol layer (e.g., for a gNB-CU 832 of an en-gNB), and the user plane part of the PDCP protocol layer and the SDAP protocol layer (e.g., for the gNB-CU 832 of a gNB). The CU-UP 832 terminates the E1 interface connected with the CU-CP 832 and the F1-U interface connected with a DU 831.

The DU 831 controls radio resources, such as time and frequency bands, locally in real time, and allocates resources to one or more UEs. The DUs 831 are network (logical) nodes hosting middle and/or lower layers of the network protocol functional split. For example, in the 3GPP NG-RAN and/or O-RAN architectures, a DU 831 hosts the radio link control (RLC), medium access control (MAC), and high-physical (PHY) layers of the gNB or en-gNB, and its operation is at least partly controlled by the CU 832. The RLC sublayer operates in one or more of a Transparent Mode (TM), Unacknowledged Mode (UM), and Acknowledged Mode (AM). The RLC sublayer performs transfer of upper layer PDUs; sequence numbering independent of the one in PDCP (UM and AM); error Correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; and/or protocol error detection (AM only). The MAC sublayer performs mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ (one HARQ entity per cell in case of CA); priority handling between UEs by means of dynamic scheduling; priority handling between logical channels of one UE by means of logical channel prioritization; priority handling between overlapping resources of one UE; and/or padding. In some implementations, a DU 831 can host a Backhaul Adaptation Protocol (BAP) layer (see e.g., 3GPP TS 38.340 v17.5.0 (2023 Jun. 30)) and/or a F1 application protocol (FIAP) (see e.g., 3GPP TS 38.470 v17.5.0 (2023 Jun. 29)), such as when the DU 831 is operating as an Integrated Access and Backhaul (IAB) node. One DU 831 supports one or multiple cells, and one cell is supported by only one DU 831. A DU 831 terminates the F1 interface connected with a CU 832. Additionally or alternatively, the DU 831 may be connected to one or more RRHs/RUs 830.

The RU 830 is a transmission/reception point (TRP) or other physical node that handles radiofrequency (RF) processing functions. The RU 830 is a network (logical) node hosting lower layers based on a lower layer functional split. For example, in 3GPP NG-RAN and/or O-RAN architectures, the RU 830 hosts low-PHY layer functions and RF processing of the radio interface based on a lower layer functional split. The RU 830 may be similar to 3GPP's transmission/reception point (TRP) or RRH, but specifically includes the Low-PHY layer. Examples of the low-PHY functions include fast Fourier transform (FFT), inverse FFT (IFFT), physical random access channel (PRACH) extraction, and the like.

Each of the CUs 832, DUs 831, and RUs 830 are connected through respective links, which may be any suitable wireless and/or wired (e.g., fiber, copper, and the like) links. In some implementations, various combinations of the CU 832, DU 831, and RU 830 may correspond to one or more of the RAN 404, AN 408, AP 406, and/or any other NAN, such as any of those discussed herein. Additional aspects of CUs 832, DUs 831, and RUs 830 are discussed in [O-RAN], [TS38401], [TS38410], and [TS38300], the contents of each of which are hereby incorporated by reference in their entireties.

In some implementations, a fronthaul gateway function (FHGW) may be disposed between the DU 831 and the RU/RRU 830 (not shown by FIG. 8), where the interface between the DU 831 and the FHGW is an Open Fronthaul (e.g., Option 7-2x) interface, the interface between FHGW function and the RU/RRU 830 is an Open Fronthaul (e.g., Option 7-2x) interface or any other suitable interface (e.g., option 7, option 8, or the like) including those that do not support Open Fronthaul (e.g., Option 7-2x). The FHGW may be packaged with one or more other functions (e.g., Ethernet switching and/or the like) in a physical device or appliance. In some implementations, a RAN controller may be communicatively coupled with the CU 832 and/or the DU 831.

The NGFI (also referred to as “xHaul” or the like) is a two-level fronthaul architecture that separates the traditional RRU 830 to BBU connectivity in the C-RAN architecture into two levels, namely levels I and II. Level I connects the RU 830 via the NGFI-I to the DU 831, and level II connects the DU 831 via the NGFI-II to the CU 832 as shown by deployment 800a in FIG. 8. The NGFI-I and NGFI-II connections may be wired connections or wireless connections, which may utilize any suitable RAT such as any of those discussed herein. The purpose of the two-level architecture is to distribute (split) the RAN node protocol functions between CU 832 and DU 831 such that latencies are reduced, giving more deployment flexibilities. In general, the NGFI-I interfaces with the lower layers of the function split which have stringent delay and data rate requirements, whereas NGFI-II interfaces with higher layers of the function split relative to the layers of the NGFI-I, rell ling the requirements for the fronthaul link. Examples of the NGFI fronthaul interfaces and functional split architectures include O-RAN 7.2x fronthaul (see e.g., [ORAN.XPSAAS] and [ORAN.CUS]), Enhanced Common Radio Interface (CPRI) based C-RAN fronthaul (see e.g., Common Public Radio Interface: eCPRI Interface Specification, cCPRI Specification v2.0 (2019 May 10), Common Public Radio Interface: Requirements for the eCPRI Transport Network, eCPRI Transport Network v1.2 (2018 Jun. 25), and [ORAN.CUS]), Radio over Ethernet (RoE) based C-RAN fronthaul (scc e.g., IEEE Standard for Radio over Ethernet Encapsulations and Mappings, IEEE Standards Association, IEEE 1914.3-2018 (5 Oct. 2018) (“[IEEE1914.3]”)), and/or the like. Additional aspects of NGFI are also discussed in [ORAN.XPSAAS], [ORAN.CUS], IEEE Standard for Packet-based Fronthaul Transport Networks, IEEE Standards Association, IEEE 1914.1-2019 (21 Apr. 2020) (“[IEEE1914.1]”), [IEEE1914.3], and Nasrallah et al., Ultra-Low Latency (ULL) Networks: A Comprehensive Survey Covering the IEEE TSN Standard and Related ULL Research, ar Xiv: 1803.07673v1 [cs.NI] (20 Mar. 2018) (“[Nasrallah]”), the contents of each of which are hereby incorporated by reference in their entireties.

In one example, the deployment 800a may implement a low level split (LLS) (also referred to as a “Lower Layer Functional Split 7-2x” or “Split Option 7-2x”) that runs between the RU 830 (e.g., an O-RU in O-RAN architectures) and the DU 831 (e.g., an O-DU in O-RAN architectures) (see e.g., [ORAN.IPC-HRD-Opt7-2], [ORAN.OMAC-HRD], [ORAN.OMC-HRD-Opt7-2], [ORAN.OMC-HRD-Opt7-2]). In this example implementation, the NGFI-I is the Open Fronthaul interface described in the O-RAN Open Fronthaul Specification (scc e.g., [ORAN.CUS]). Other LLS options may be used such as the relevant interfaces described in other standards or specifications such as, for example, the 3GPP NG-RAN functional split (see e.g., [TS38401] and 3GPP TR 38.801 v14.0.0 (2017 Apr. 3)), the Small Cell Forum for Split Option 6 (scc e.g., 5G small cell architecture and product definitions: Configurations and Specifications for companies deploying small cells 2020-2025, Small Cell Forum, document 238.10.01 (5 Jul. 2020) (“[SCF238]”), 5G NR FR1 Reference Design: The case for a common, modular architecture for 5G NR FR1 small cell distributed radio units, Small Cell Forum, document 251.10.01 (15 Dec. 2021) (“[SCF251]”), and [ORAN.IPC-HRD-Opt6], the contents of each of which are hereby incorporated by reference in their entireties), and/or in O-RAN white-box hardware Split Option 8 (e.g., [ORAN.IPC-HRD-Opt8]).

Additionally or alternatively, the CUS 832, DUs 831, and/or RUs 830 may be IAB nodes. IAB enables wireless relaying in an NG-RAN where a relaying node (referred to as an “IAB-node”) supports access and backhauling via 3GPP 5G/new radio (NR) links/interfaces. The terminating node of NR backhauling on the network side is referred to as an “IAB-donor”, which represents a RAN node (e.g., a gNB) with additional functionality to support IAB. Backhauling can occur via a single or via multiple hops. All IAB-nodes that are connected to an IAB-donor via one or multiple hops form a directed acyclic graph (DAG) topology with the IAB-donor as its root. The IAB-donor performs centralized resource, topology and route management for the IAB topology. The IAB architecture is shown and described in [TS38300].

Although the NGF deployment 800a shows the CU 832, DU 831, RRH 830, and CN 842 as separate entities, in other implementations some or all of these network nodes can be bundled, combined, or otherwise integrated with one another into a single device or element, including collapsing some internal interfaces (e.g., F1-C, F1-U, E1, E2, and the like). At least the following implementations are possible: (i) integrating the CU 832 and the DU 831 (e.g., a CU-DU), which is connected to the RRH 830 via the NGFI-I; (ii) integrating the DU 831 and the RRH 830 integrated (e.g., CU-DU), which is connected to the CU 832 via NGFI-II; (iii) integrating a RAN controller and the CU 832, which is connected to the DU 831 via NGFI-II; (iv) integrating the CU 832, the DU 831, and the RU 830, which is connected to the CN 842 via backhaul interface; and (v) integrating the network controller (or intelligent controller), the CU 832, the DU 831, and the RU 830. Any of the aforementioned example implementations involving the CU 832 may also include integrating the CU-CP 832 and CP-UP 832.

FIG. 8 also shows an example RAN disaggregation deployment 800b (also referred to as “disaggregated RAN 800b”) where the UE 802 is connected to the RRH 830, and the RRH 830 is communicatively coupled with one or more of the RAN functions (RANFs) 1-N (where N is a number). The RANFs 1-N are disaggregated and distributed geographically across several component segments and network nodes. In some implementations, each RANF 1-N is a software (SW) element operated by a physical compute node and the RRH 830 includes radiofrequency (RF) circuitry (e.g., an RF propagation module for a particular RAT and/or the like). In this example, the RANF 1 is operated on a physical compute node that is co-located with the RRH 830 and the other RANFs are disposed at locations further away from the RRH 830. Additionally in this example, the CN 842 is also disaggregated into CN NFs 1-x (where x is a number) in a same or similar manner as the RANFs 1-N, although in other implementations the CN 842 is not disaggregated.

Network disaggregation (or disaggregated networking) involves the separation of networking equipment into functional components and allowing each component to be individually deployed. This may encompass separation of SW elements (e.g., NFs) from specific HW elements and/or using APIs to enable software defined network (SDN) and/or and NF virtualization (NFV). RAN disaggregation involves network disaggregation and virtualization of various RANFs (e.g., RANFs 1-N in FIG. 8). The RANFs 1-N can be placed in different physical sites in various topologies in a RAN deployment based on the use case. This enables RANF distribution and deployment over different geographic areas and allows a breakout of RANFs to support various use cases (e.g., low latency use cases and the like) as well as flexible RAN implementations. Disaggregation offers a common or uniform RAN platform capable of assuming a distinct profile depending on where it is deployed. This allows fewer fixed-function devices, and a lower total cost of ownership, in comparison with existing RAN architectures. Example RAN disaggregation frameworks are provided by Telecom Infra Project (TIP) OpenRAN™, Cisco® Open vRAN™, [O-RAN], Open Optical & Packet Transport (OOPT), Reconfigurable Optical Add Drop Multiplexer (ROADM), and/or the like.

In any of the implementations discussed herein, the lower layers of the RAN protocol stack can be characterized by real-time (RT) functions and relatively complex signal processing algorithms, and the higher layers of the RAN protocol stack can be characterized by non-RT functions. In these implementations, the RT functions and signal processing algorithms can be implemented in DUs 831 and/or RRHs 830 either using purpose-built network elements or in COTS hardware augmented with purpose-built HW accelerators.

FIG. 8 also shows various functional split options 800c, for both DL and UL directions. The traditional RAN is an integrated network architecture based on a distributed RAN (D-RAN) model, where D-RAN integrates all RANFs into a few network elements. As alluded to previously, the disaggregated RAN architecture provides flexible function split options to overcome various drawbacks of the D-RAN model. The disaggregated RAN breaks up the integrated network system into several function components that can then be individually re-located as needed without hindering their ability to work together to provide a holistic network services. The split options 800c are mostly split between the CU 832 and the DU 831, but can include a split between the CU 832, DU 831, and RU 830. For each option 800c, protocol entities on the left side of the figure are included in the RANF implementing the CU 832 and the protocol entities on the right side of the figure are included in the RANF implementing the DU 831.

FIG. 9 depicts an example of management services (MnS) deployment 900, in accordance with one or more example embodiments of the present disclosure.

MnS is a Service Based Management Architecture (SBMA). An MnS is a set of offered management capabilities (e.g., capabilities for management and orchestration (MANO) of network and services). The entity producing an MnS is referred to as an MnS producer (MnS-P) and the entity consuming an MnS is referred to as an MnS consumer (MnS-C). An MnS provided by an MnS-P can be consumed by any entity with appropriate authorization and authentication. The MnS-P offers its services via a standardized service interface composed of individually specified MnS components (e.g., MnS-C).

A MnS is specified using different independent components. A concrete MnS includes at least two of these components. Three different component types are defined, including MnS component type A, MnS component type B, and MnS component type C. An MnS component type A is a group of management operations and/or notifications that is agnostic with regard to the entities managed. The operations and notifications as such are hence not involving any information related to the managed network. These operations and notifications are called generic or network agnostic. For example, operations for creating, reading, updating and deleting managed object instances, where the managed object instance to be manipulated is specified only in the signature of the operation, are generic. An MnS component type B refers to management information represented by information models representing the managed entities. An MnS component type B is also called Network Resource Model (NRM) (see e.g., [TS28622], [TS28541]). MnS component type C is performance information of the managed entity and fault information of the managed entity. Examples of management service component type C include alarm information (see e.g., [TS28532] and [TS28545]) and performance data (see e.g., [TS28552], [TS28554], and [TS32425]).

An MnS-P is described by a set of metadata called MnS-P profile. The profile holds information about the supported MnS components and their version numbers. This may include also information about support of optional features. For example, a read operation on a complete subtree of managed object instances may support applying filters on the scoped set of objects as optional feature. In this case, the MnS profile should include the information if filtering is supported.

FIG. 9 also depicts an example management function (MnF) deployment 910. The MnF is a logical entity playing the roles of MnS-C and/or MnS-P. An MnF with the role of management service exposure governance is referred to as an “Exposure governance management function” or “exposure governance MnF”. An MnS produced by an MnF 910 may have multiple consumers. The MnF 910 may consume multiple MnS from one or multiple MnS-Ps. In the MnF deployment 910, the MnF plays both roles (e.g., MnS-P and MnS-C). An MnF can be deployed as a separate entity or embedded in a network function (NF) to provide MnS(s). For example, MnF deployment scenario 920 shows an example where the MnF is deployed as a separate entity to provide MnS(s) and MnF deployment scenario 930 in which an MnF is embedded in an NF to provide MnS(s). In these examples, the MnFs may interact by consuming MnS produced by other MnFs

The 3GPP management system is also capable to consume NFV MANO interface (e.g., Os-Ma-nfvo, Ve-Vnfm-em, and Ve-Vnfm-vnf reference points). An MnS-P can consume management interfaces provided by NFV MANO for at least the following purposes: network service LCM; and VNF LCM, PM, FM, CM on resources supporting VNF.

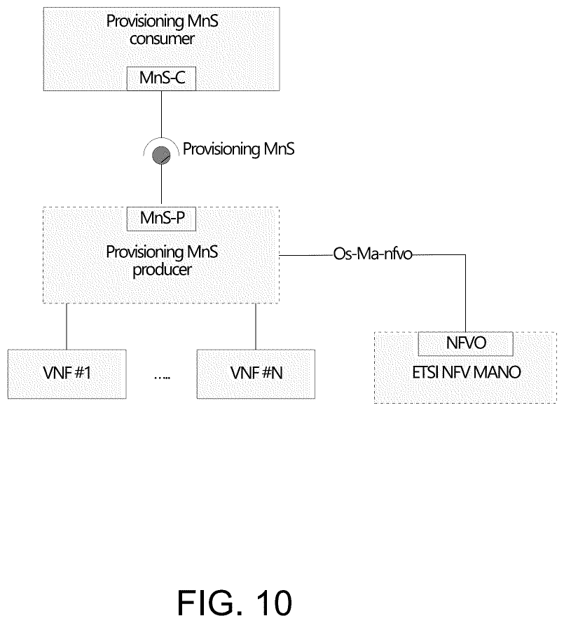

FIG. 10 shows an example framework of provisioning MnS where an MnS-P interfaces to an ETSI NFV MANO to support lifecycle management of VNFs.

Machine learning (ML) involves programming computing systems to optimize a performance criterion using example (training) data and/or past experience. ML refers to the use and development of computer systems that are able to learn and adapt without following explicit instructions, by using algorithms and/or statistical models to anal9e and draw inferences from patterns in data. ML involves using algorithms to perform specific task(s) without using explicit instructions to perform the specific task(s), but instead relying on learnt patterns and/or inferences. ML uses statistics to build mathematical model(s) (also referred to as “ML models” or simply “models”) in order to make predictions or decisions based on sample data (e.g., training data). The model is defined to have a set of parameters, and learning is the execution of a computer program to optimize the parameters of the model using the training data or past experience. The trained model may be a predictive model that makes predictions based on an input dataset, a descriptive model that gains knowledge from an input dataset, or both predictive and descriptive. Once the model is learned (trained), it can be used to make inferences (e.g., predictions).

ML algorithms perform a training process on a training dataset to estimate an underlying ML model. An ML algorithm is a computer program that learns from experience with respect to some task(s) and some performance measure(s)/metric(s), and an ML model is an object or data structure created after an ML algorithm is trained with training data. In other words, the term “ML model” or “model” may describe the output of an ML algorithm that is trained with training data. After training, an ML model may be used to make predictions on new datasets. Additionally, separately trained AI/ML models can be chained together in a AI/ML pipeline during inference or prediction generation. Although the term “ML algorithm” refers to different concepts than the term “ML model,” these terms may be used interchangeably for the purposes of the present disclosure. Any of the ML techniques discussed herein may be utilized, in whole or in part, and variants and/or combinations thereof, for any of the example embodiments discussed herein.

ML may require, among other things, obtaining and cleaning a dataset, performing feature selection, selecting an ML algorithm, dividing the dataset into training data and testing data, training a model (e.g., using the selected ML algorithm), testing the model, optimizing or tuning the model, and determining metrics for the model. Some of these tasks may be optional or omitted depending on the use case and/or the implementation used.

ML algorithms accept model parameters (or simply “parameters”) and/or hyperparameters that can be used to control certain properties of the training process and the resulting model. Model parameters are parameters, values, characteristics, configuration variables, and/or properties that are learnt during training. Model parameters are usually required by a model when making predictions, and their values define the skill of the model on a particular problem. Hyperparameters at least in some examples are characteristics, properties, and/or parameters for an ML process that cannot be learnt during a training process. Hyperparameter are usually set before training takes place, and may be used in processes to help estimate model parameters.

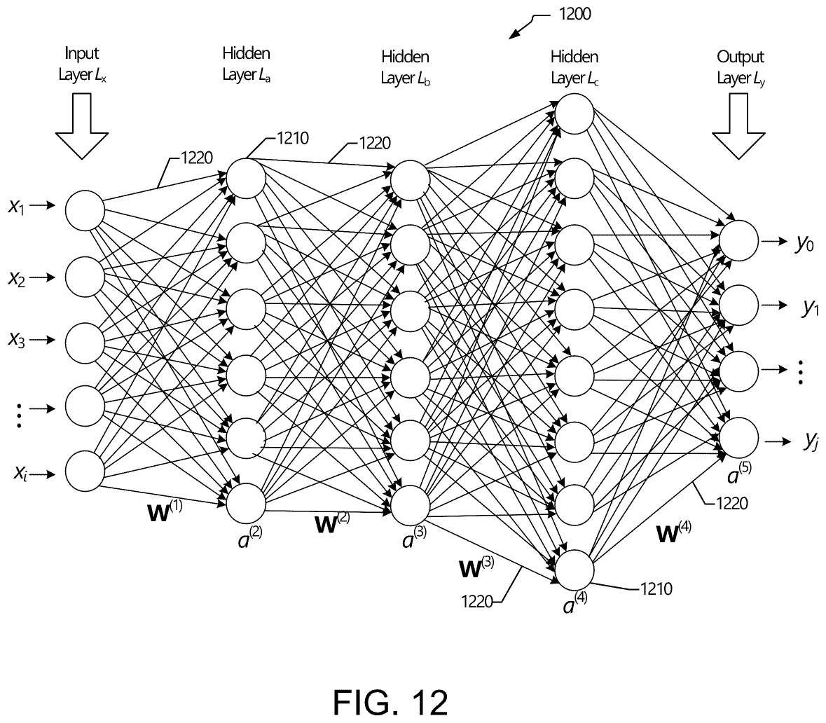

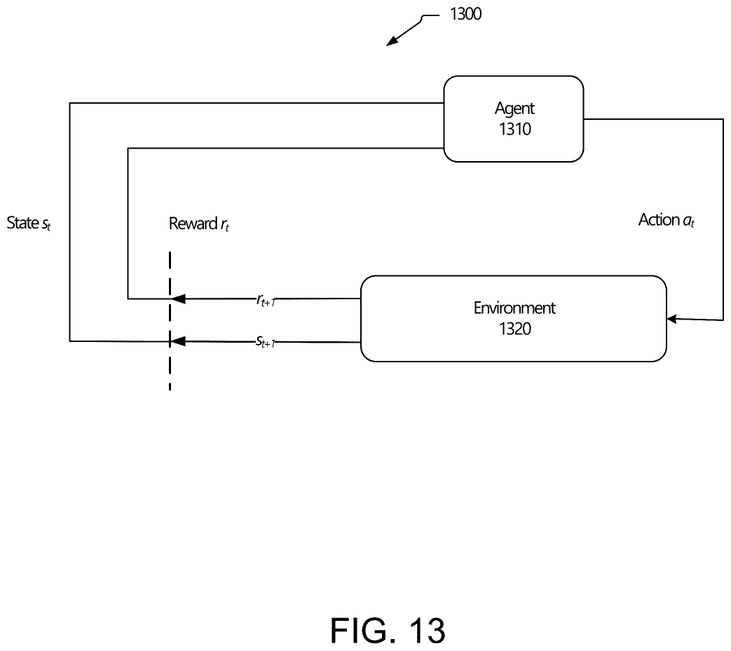

ML techniques generally fall into the following main types of learning problem categories: supervised learning, unsupervised learning, and reinforcement learning. Supervised learning involves building models from a set of data that contains both the inputs and the desired outputs. Unsupervised learning is an ML task that aims to learn a function to describe a hidden structure from unlabeled data. Unsupervised learning involves building models from a set of data that contains only inputs and no desired output labels. Reinforcement learning (RL) is a goal-oriented learning technique where an RL agent aims to optimize a long-term objective by interacting with an environment. Some implementations of AI and ML use data and neural networks (NNs) in a way that mimics the working of a biological brain. Examples of such implementations are shown by FIGS. 12 and 13.

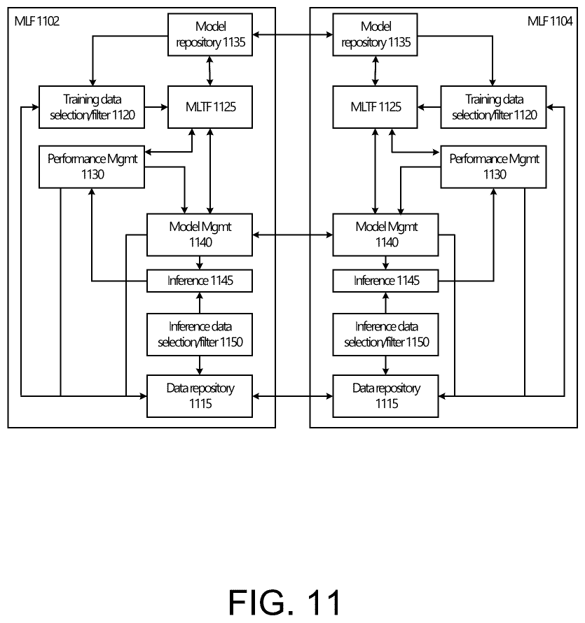

FIG. 11 depicts an example AI/ML-assisted communication network, in accordance with one or more embodiments of the present disclosure.

The AI/ML-assisted communication network includes communication between an ML function (MLF) 1102 and an MLF 1104. More specifically, as described in further detail below, AI/ML models may be used or leveraged to facilitate wired and/or over-the-air communication between the MLF 1102 and the MLF 1104. In this example, the MLF 1102 and the MLF 1104 operate in a matter consistent with 3GPP technical specifications and/or technical reports for 5G and/or 6G systems. In some examples, the communication mechanisms between the MLF 1102 and the MLF 1104 include any suitable access technologies and/or RATs, such as any of those discussed herein. Additionally, the communication mechanisms in FIG. 11 may be part of, or operate concurrently with the components, devices, systems, networks, and/or deployments of FIGS. 1, 2, 3, 4, 7, 8, 10, 11, 12-13, and/or some other components, devices, systems, networks, and/or deployments described herein.

The MLFs 1102, 1104 may correspond to any of the entities/elements discussed herein. In one example, the MLF 1102 corresponds to an MnF and/or MnS-P and the MLF 1104 corresponds to a consumer 310, an MnS-C, or vice versa. Additionally or alternatively, the MLF 1102 corresponds to a set of the MLFs of FIGS. 9-10 and the MLF 1104 corresponds to a different set of the MLFs of FIGS. 9-10. In this example, the sets of MLFs may be mutually exclusive, or some or all of the MLFs in each of the sets of MLFs may overlap or be shared. In another example, the MLF 1102 and/or the MLF 1104 is/are implemented by respective UEs (e.g., UE 402, UE 502). Additionally or alternatively, the MLF 1102 and/or the MLF 1104 is/are implemented by a same UE or different UEs. In another example, the MLF 1102 and/or the MLF 1104 is/are implemented by respective RANs (e.g., RAN 404) or respective NANs (e.g., AP 406, NAN 414, NAN 504).

As shown by FIG. 11, the MLF 1102 and the MLF 1104 include various AI/ML-related components, functions, elements, or entities, which may be implemented as hardware, software, firmware, and/or some combination thereof. In some examples, one or more of the AI/ML-related elements are implemented as part of the same hardware (e.g., IC, chip, or multi-processor chip), software (e.g., program, process, engine, and/or the like), or firmware as at least one other component, function, element, or entity. The AI/ML-related elements of MLF 1102 may be the same or similar to the AI/ML-related elements of MLF 1104. For the sake of brevity, description of the various elements is provided from the point of view of the MLF 1102, however it will be understood that such description applies to like named/numbered elements of MLF 1104, unless explicitly stated otherwise.

The data repository 1115 is responsible for data collection and storage. As examples, the data repository 1115 may collect and store RAN configuration parameters, NF configuration parameters, measurement data, RLM data, key performance indicators (KPIs), SLAs, model performance metrics, knowledge base data, ground truth data, ML model parameters, hyperparameters, and/or other data for model training, update, and inference. In some examples, a data collection function (not shown) is part or connected to the data repository 1115. The data collection function is a function that provides input data to the MLTF 1125 and model inference function 1145. AI/ML algorithm-specific data preparation (e.g., data pre-processing and cleaning, formatting, and transformation) may or may not be carried out in the data collection function 1105. Examples of input data may include measurements from UEs 402, RAN nodes 414, and/or additional or alternative network entities; feedback from actor 1120; and/or output(s) from AI/ML model(s). The input data fed to the MLTF 1125 is training data, and the input data fed to the model inference function 1145 is inference data.

The collected data is stored in/by the repository 1115, and the stored data can be discovered and extracted by other elements from the data repository 1115. For example, the inference data selection/filter 1150 may retrieve data from the data repository 1115 and provide that data to the inference engine 1145 for generating/determining inferences. In various examples, the MLF 1102 is configured to discover and request data from the data repository 1115 in the MLF 1104, and/or vice versa. In these examples, the data repository 1115 of the MLF 1102 may be communicatively coupled with the data repository 1115 of the MLF 1104 such that the respective data repositories 1115 may share collected data with one another. Additionally or alternatively, the MLF 1102 and/or MLF 1104 is/are configured to discover and request data from one or more external sources and/or data storage systems/devices.

The training data selection/filter 1120 is configured to generate training, validation, and testing datasets for ML training (MLT) (or ML model training). One or more of these datasets may be extracted or otherwise obtained from the data repository 1115. Data may be selected/filtered based on the specific AI/ML model to be trained. Data may optionally be transformed, augmented, and/or pre-processed (e.g., normalized) before being loaded into datasets. The training data selection/filter 1120 may label data in datasets for supervised learning, or the data may remain unlabeled for unsupervised learning. The produced datasets may then be fed into the MLT function (MLTF) 1125.

The MLTF 1125 is responsible for training and updating (e.g., tuning and/or re-training) AI/ML models. A selected model (or set of models) may be trained using the fed-in datasets (including training, validation, testing) from the training data selection/filtering 1120. The MLTF 1125 produces trained and tested AI/ML models that are ready for deployment. The produced trained and tested models can be stored in a model repository 1135. Additionally or alternatively, the MLTF 1125 performs AI/ML model training, validation, and testing. The MLTF 1125 may generate model performance metrics as part of the model testing procedure and/or as part of the model validation procedure. Examples of the model performance metrics are discussed infra. The MLTF 1125 may also be responsible for data preparation (e.g., data pre-processing and cleaning, formatting, and transformation) based on training data delivered by the data collection function and/or the training data selection/filter 1120, if required. The MLTF 1125 performs model deployment/updates, wherein the MLTF 1125 initially deploys a trained, validated, and tested AI/ML model to the model inference function 1145, and/or delivers updated model(s) to the model inference function 1145. Examples of the model deployments and updates are discussed infra.

The model repository 1135 is responsible for AI/ML models' (both trained and un-trained) storage and exposure. Various model data can be stored in the model repository 1135. The model data can include, for example, trained/updated model(s), model parameters, hyperparameters, and/or model metadata, such as model performance metrics, hardware platform/configuration data, model execution parameters/conditions, and/or the like. In some examples, the model data can also include inferences made when operating the ML model. Examples of AI/ML models and other ML model aspects are discussed infra w.r.t FIGS. 11 and 12. The model data may be discovered and requested by other MLF components (e.g., the training data selection/filter 1120 and/or the MLTF 1125). In some examples, the MLF 1102 can discover and request model data from the model repository 1135 of the MLF 1104. Additionally or alternatively, the MLF 1104 can discover and/or request model data from the model repository 1135 of the MLF 1102. In some examples, the MLF 1104 may configure models, model parameters, hyperparameters, model execution parameters/conditions, and/or other ML model aspects in the model repository 1135 of the MLF 1102.

The model management (mgmt) function 1140 is responsible for mgmt of the AI/ML model produced by the MLTF 1125. Such mgmt functions may include deployment of a trained model, monitoring ML entity (also referred to as ML mode) performance, reporting ML entity validation and/or performance data, and/or the like. In model deployment, the model mgmt 1140 may allocate and schedule hardware and/or software resources for inference, based on received trained and tested models. For purposes of the present disclosure, the term “inference” refers to the process of using trained AI/ML model(s) to generate statistical inferences, predictions, decisions, probabilities and/or probability distributions, actions, configurations, policies, data analytics, outcomes, optimizations, and/or the like based on new, unseen data (e.g., “input inference data”). In some examples, the inference process can include feeding input inference data into the ML model (e.g., inference engine 1145), forward passing the input inference data through the ML model's architecture/topology wherein the ML model performs computations on the data using its learned parameters (e.g., weights and biases), and predictions output. In some examples, the inference process can include data transformation before the forward pass, wherein the input inference data is preprocessed or transformed to match the format required by the ML model. In performance monitoring, based on model performance KPIs and/or metrics, the model mgmt 1140 may decide to terminate the running model, start model re-training and/or tuning, select another model, and/or the like. In examples, the model mgmt 1140 of the MLF 1104 may be able to configure model mgmt policies in the MLF 1102, and vice versa.

The inference data selection/filter 1150 is responsible for generating datasets for model inference at the inference 1145, as described infra. For example, inference data may be extracted from the data repository 1115. The inference data selection/filter 1150 may select and/or filter the data based on the deployed AI/ML model. Data may be transformed, augmented, and/or pre-processed in a same or similar manner as the transformation, augmentation, and/or pre-processing of the training data selection/filtering as described w.r.t training data selection filter 1120. The produced inference dataset may be fed into the inference engine 1145.

The inference engine 1145 (also referred to as “model inference function 1145” and/or the like) is responsible for executing/generating inferences as described herein. The inference engine 1145 consumes an inference dataset provided by the inference data selection/filter 1150, and generates an AI/ML model inference output, which includes one or more inferences. The inferences may be or include, for example, statistical inferences, predictions, decisions, probabilities and/or probability distributions, actions, configurations, policies, data analytics, outcomes, optimizations, and/or the like. The inference(s)/outcome(s) may be provided to the performance measurement function 1130. The model inference function 1145 may provide model performance feedback to the MLTF 1125 and/or the performance measurement function 1130, when applicable. The model performance feedback may include various performance metrics (e.g., any of those discussed herein) related to producing inferences. The model performance feedback may be used for monitoring the performance of the AI/ML model, when available. The model inference function 1145 may also be responsible for data preparation (e.g., data pre-processing and cleaning, formatting, and transformation) based on inference data delivered by the data collection function and/or the inference data selection/filter 1150, if required. The model inference function 1145 produces an inference output, which is the inferences generated or otherwise produced when the model inference function 1145 operates the AI/ML model using the inference data (set). Details of inference output are use case specific and may be based on the specific type of AI/ML model being used (see e.g., FIGS. 12-13).

In some examples, the model inference function 1145 provides the inference output to an actor (not shown). The actor is a function, engine, component, device, system, network, and/or other entity that receives an inference output from the model inference function 1145, and triggers or otherwise performs corresponding action(s) based on the inference output. The actor may trigger actions directed to other entities and/or to itself. In some examples, the actor is an network energy savings (NES) function, a mobility robustness optimization (MRO) function, a load balancing optimization (LBO) function, and/or some other self-organizing network (SON) function. Additionally or alternatively, the inference output is related to NES, MRO, and/or LBO, and the actor is one or more RAN nodes 414 that perform various to NES, MRO, and/or LBO operations based on the inferences. The actor may also provide feedback to the performance measurement function 1130 and/or the data collection function/data repository 1115 for storage. The actor feedback includes information related to the actions performed by the actor. The feedback includes, for example, any information that may be needed to derive training data, testing data, and/or validation data; inference data; and/or data to monitor the performance of the AI/ML model and its impact to the network through updating of KPIs, performance counters, and/or the like.

The performance measurement function 1130 is configured to measure model performance metrics (e.g., accuracy, momentum, precision, quantile, recall/sensitivity, model bias, run-time latency, resource consumption, and/or other suitable metrics/measures, such as any of those discussed herein) of deployed and executing models based on the inference(s) for monitoring purposes. Model performance data may be stored in the data repository 1115 and/or reported according to the validation reporting mechanisms discussed herein.

The performance metrics that may be measured and/or predicted by the performance measurement function 1130 may be based on the particular AI/ML task and the other inputs/parameters of the ML entity. The performance metrics may include model-based metrics and platform-based metrics. The model-based metrics are metrics related to the performance of the model itself and/or without considering the underlying hardware platform. The platform-based metrics are metrics related to the performance of the underlying hardware platform when operating the ML model.

FIG. 12 illustrates an example neural network, in accordance with one or more embodiments.

The NN 1200 may be suitable for use by one or more of the computing systems (or subsystems) of the various implementations discussed herein, implemented in part by a HW accelerator, and/or the like. The NN 1200 may be deep neural network (DNN) used as an artificial brain of a compute node or network of compute nodes to handle very large and complicated observation spaces. Additionally or alternatively, the NN 1500 can be some other type of topology (or combination of topologies), such as a convolution NN (CNN), deep CNN (DCN), recurrent NN (RNN), Long Short Term Memory (LSTM) network, a Deconvolutional NN (DNN), gated recurrent unit (GRU), deep belief NN, a feed forward NN (FFN), a deep FNN (DFF), deep stacking network, Markov chain, perception NN, Bayesian Network (BN) or Bayesian NN (BNN), Dynamic BN (DBN), Linear Dynamical System (LDS), Switching LDS (SLDS), Optical NNs (ONNs), an NN for reinforcement learning (RL) and/or deep RL (DRL), and/or the like. NNs are usually used for supervised learning, but can be used for unsupervised learning and/or RL.

The NN 1200 may encompass a variety of ML techniques where a collection of connected artificial neurons 1210 that (loosely) model neurons in a biological brain that transmit signals to other neurons/nodes 1210. The neurons 1210 may also be referred to as nodes 1210, processing elements (PEs) 1210, or the like. The connections 1220 (or edges 1220) between the nodes 1210 are (loosely) modeled on synapses of a biological brain and convey the signals between nodes 1210. Note that not all neurons 1210 and edges 1220 are labeled in FIG. 12 for the sake of clarity.

Each neuron 1210 has one or more inputs and produces an output, which can be sent to one or more other neurons 1210 (the inputs and outputs may be referred to as “signals”). Inputs to the neurons 1210 of the input layer Lₓ can be feature values of a sample of external data (e.g., input variables xᵢ). The input variables xᵢ can be set as a vector containing relevant data (e.g., observations, ML features, and the like). The inputs to hidden units 1210 of the hidden layers Lₐ, L_{b}, and L_{c} may be based on the outputs of other neurons 1210. The outputs of the final output neurons 1210 of the output layer L_{y} (e.g., output variables yⱼ) include predictions, inferences, and/or accomplish a desired/configured task. The output variables yⱼ may be in the form of determinations, inferences, predictions, and/or assessments. Additionally or alternatively, the output variables yⱼ can be set as a vector containing the relevant data (e.g., determinations, inferences, predictions, assessments, and/or the like).

FIG. 13 shows an RL architecture 1300 comprising an agent 1310 and an environment 1320. The agent 1310 (e.g., software agent or AI agent) is the learner and decision maker, and the environment 1320 comprises everything outside the agent 1310 that the agent 1310 interacts with. The environment 1320 is typically stated in the form of a Markov decision process (MDP), which may be described using dynamic programming techniques. An MDP is a discrete-time stochastic control process that provides a mathematical framework for modeling decision making in situations where outcomes are partly random and partly under the control of a decision maker.

The following examples pertain to further embodiments.

Example 1 may include an apparatus of a Service Based Management Architecture (SBMA) Management Service (MnS) Producer, the apparatus comprising processing circuitry coupled to storage for storing information associated with performance measurements for one-way uplink packet delay in wireless communications, the processing circuitry configured to: identify performance measurements, received from a network function (NF) of a 5th Generation (5G) wireless network, indicative of uplink packet delay between a user equipment (UE) and a protocol data unit (PDU) session anchor (PSA) user plane function (UPF) of the 5G wireless network; detect whether the performance measurements indicate that the uplink packet delay includes an uplink Packet Data Convergence Protocol (PDCP) delay occurred in the UE (D1); and generate performance metrics for the NF based on the performance measurements.

Example 2 may include the apparatus of example 1 and/or any other example herein, wherein the uplink packet delay comprises a radio access network (RAN) delay and a core network (CN) delay.

Example 3 may include the apparatus of example 1 and/or any other example herein, wherein the processing circuitry is further configured to provide the performance metrics to an MnS consumer.

Example 4 may include the apparatus of example 1 and/or any other example herein, wherein the MnS Producer is implemented within the NF.

Example 5 may include the apparatus of example 1 and/or any other example herein, wherein the MnS Producer is implemented within a second NF different than the NF.

Example 6 may include the apparatus of example 1 and/or any other example herein, wherein the uplink packet delay is an average uplink packet delay not including the D1.

Example 7 may include the apparatus of example 6 and/or any other example herein, wherein the average uplink packet delay not including the D1 is received from a UPF and generated by the UPF by: performing, by the UPF, Quality of Service (QOS) monitoring based on a request received from a session management function (SMF) of the 5G wireless network during a PDU Session Establishment or Modification procedure, wherein for each received General Packet Radio Service (GPRS) Tunneling Protocol (GTP) PDU monitoring response packet (packet i) for QoS monitoring, the PSA UPF records the following time stamps and information: T3 received in a GTP-U header of the monitoring response packet, indicating a local time that the monitoring response packet was sent by a Next Generation RAN (NG-RAN), T4 indicating that the monitoring response packet was received by the PSA UPF, a UL Delay Result from the UE to the NG-RAN indicating an uplink delay measurement result that is a sum of a delay incurred in the NG-RAN, including a delay at a 5G Next Generation base station (gNB)-Central Unit User Plane (UP) (gNB-CU-UP), on an an F1-U interface, and on a gNB Distributed Unit (gNB-DU), and a delay over an Uu interface, excluding a D1 UL PDCP delay occurred in the UE, wherein a Single-Network Slice Selection Assistance (S-NSSAI) is associated to the GTP PDU monitoring response packet, and wherein the PSA UPF counts a number (N) of GTP PDU monitoring response packets for each S-NSSAI, and calculates a respective S-NSSAI for each GTP PDU monitoring response packet.

Example 8 may include the apparatus of example 1 and/or any other example herein, wherein the uplink packet delay is a distribution of uplink packet delay not including the D1.

Example 9 may include the apparatus of example 8 and/or any other example herein, wherein the distribution of uplink packet delay not including the D1 is received from a UPF and generated by the UPF by: performing, by the UPF, QOS monitoring based on a request received from an SMF of the 5G wireless network during an PDU Session Establishment or Modification procedure, wherein for each received GTP PDU monitoring response packet (packet i) for QoS monitoring, the PSA UPF records the following time stamps and information: T3 received in a GTP-U header of the monitoring response packet, indicating a local time that the monitoring response packet was sent by an NG-RAN, T4 indicating that the monitoring response packet was received by the PSA UPF, a UL Delay Result from the UE to the NG-RAN indicating an uplink delay measurement result that is a sum of the delay incurred in NG-RAN, including a delay at an gNB-CU-UP, on an F1-U interface, and on a gNB-DU, and a delay over an Uu interface, excluding the D1 UL PDCP delay occurred in the UE, wherein an S-NSSAI is associated to the GTP PDU monitoring response packet, and wherein the PSA UPF performs a calculation for each GTP PDU monitoring response packet (packet i) for each S-NSSAI, and increments a corresponding bin with a delay range in which a result of the respective calculation falls into by 1 for a subcounter per the S-NSSAI.

Example 10 may include the apparatus of example 1 and/or any other example herein, wherein the uplink packet delay is an average uplink packet delay including the D1.

Example 11 may include the apparatus of example 10 and/or any other example herein, wherein the average uplink packet delay including D1 is received from a UPF and is generated by the UPF by: performing, by the UPF, QOS monitoring based on a request received from an SMF of the 5G wireless network during a PDU Session Establishment or Modification procedure, wherein for each received GTP PDU monitoring response packet (packet i) for QoS monitoring, the PSA UPF records the following time stamps and information: T3 received in a GTP-U header of the monitoring response packet, indicating a local time that the monitoring response packet was sent by an NG-RAN, T4 indicating that the monitoring response packet was received by the PSA UPF, a UL Delay Result from the UE to the NG-RAN, indicating an uplink delay measurement result that is a sum of a delay incurred in the NG-RAN, including a delay at agNB-CU-UP, on an F1-U interface, and on a gNB-DU, and a delay over an Uu interface, wherein the D1 UL PDCP delay occurred in the UE, and an S-NSSAI associated to the GTP PDU monitoring response packet, wherein the PSA UPF counts a number (N) of GTP PDU monitoring response packets for each S-NSSAI, and performs a calculation for each S-NSSAI.

Example 12 may include the apparatus of example 1 and/or any other example herein, wherein the uplink packet delay is a distribution of uplink packet delay including the D1.

Example 13 may include the apparatus of example 12 and/or any other example herein, wherein the distribution of uplink packet delay including D1 is received from a UPF and is generated by the UPF by: performing, by the UPF, QOS monitoring per a request received from an SMF during a PDU Session Establishment or Modification procedure, wherein for each received GTP PDU monitoring response packet (packet i) for QoS monitoring, the PSA UPF records the following time stamps and information: T3 received in a GTP-U header of the monitoring response packet, indicating a local time that the monitoring response packet was sent by an NG-RAN; T4 indicating that the monitoring response packet was received by the PSA UPF, a UL Delay Result from the UE to the NG-RAN, indicating the uplink delay measurement result that is a sum of a delay incurred in the NG-RAN, including a delay at a gNB-CU-UP, on an F1-U interface, and on a gNB-DU, and a delay over an Uu interface, and the D1 UL PDCP delay occurred in the UE, and an S-NSSAI associated to the GTP PDU monitoring response packet, wherein the PSA UPF performs a calculation for each GTP PDU monitoring response packet (packet i) for each S-NSSAI, and increments a corresponding bin with a delay range in which the result of the respective calculation falls into by 1 for a subcounter per S-NSSAI.

Example 14 may include a non-transitory computer-readable storage medium comprising instructions to cause processing circuitry of a Service Based Management Architecture (SBMA) Management Service (MnS) Producer for performing performance measurements for one-way uplink packet delay in wireless communications, upon execution of the instructions by the processing circuitry, to: identify performance measurements, received from a network function (NF) of a 5th Generation (5G) wireless network, indicative of uplink packet delay between a user equipment (UE) and a protocol data unit (PDU) session anchor (PSA) user plane function (UPF) of the 5G wireless network; detect whether the performance measurements indicate that the uplink packet delay includes an uplink PDCP delay occurred in the UE (D1); and generate performance metrics for the NF based on the performance measurements.

Example 15 may include the non-transitory computer-readable storage medium of example 14 and/or any other example herein, wherein the uplink packet delay comprises a radio access network (RAN) delay and a core network (CN) delay.

Example 16 may include the non-transitory computer-readable storage medium of example 14 and/or any other example herein, wherein the processing circuitry is further configured to provide the performance metrics to an MnS Consumer.

Example 17 may include the non-transitory computer-readable storage medium of example 14 and/or any other example herein, wherein the MnS Producer is implemented within the NF.

Example 18 may include a method for performing performance measurements for one-way uplink packet delay in wireless communications, the method comprising: identifying, by processing circuitry of a Service Based Management Architecture (SBMA) Management Service (MnS) Producer, a precoder rank indicator for use in an eight-transmitter uplink transmission by a UE device, performance measurements, received from a network function (NF) of a 5th Generation (5G) wireless network, indicative of uplink packet delay between a user equipment (UE) and a protocol data unit (PDU) session anchor (PSA) user plane function (UPF) of the 5G wireless network; detecting, by the processing circuitry, whether the performance measurements indicate that the uplink packet delay includes an uplink PDCP delay occurred in the UE (D1); and generating, by the processing circuitry, performance metrics for the NF based on the performance measurements.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-M11, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Various embodiments are described below.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

Unless used differently herein, terms, definitions, and abbreviations may be consistent with terms, definitions, and abbreviations defined in 3GPP TR 21.905 v16.0.0 (2019 June) and/or any other 3GPP standard. For the purposes of the present document, the following abbreviations (shown in Table 2) may apply to the examples and embodiments discussed herein.

TABLE 2
Abbreviations

| | |
|---|---|
| 3GPP | Third Generation Partnership Project |
| 4G | Fourth Generation |
| 5G | Fifth Generation |
| 5GC | 5G Core network |
| AC | Application Client |
| ACK | Acknowledgement |
| ACID | Application Client Identification |
| AF | Application Function |
| AM | Acknowledged Mode |
| AMBR | Aggregate M11imum Bit Rate |
| AMF | Access and Mobility Management Function |
| AN | Access Network |
| ANR | Automatic Neighbour Relation |
| AP | Application Protocol, |
| | Antenna Port, |
| | Access Point |
| API | Application Programming Interface |
| APN | Access Point Name |
| ARP | Allocation and Retention Priority |
| ARQ | Automatic Repeat Request |
| AS | Access Stratum |
| ASP | Application Service Provider |
| ASN.1 | Abstract Synt11 Notation One |
| AUSF | Authentication Server Function |
| AWGN | Additive White Gaussian Noise |
| BAP | Backhaul Adaptation Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote Access Server |
| BSS | Business Support System |
| BS | Base Station |
| BSR | Buffer Status Report |
| BW | Bandwidth |
| BWP | Bandwidth Part |
| C-RNTI | Cell Radio Network Temporary Identity |
| CA | Carrier Aggregation, |
| | Certification Authority |
| CAPEX | CAPital Expenditure |
| CBRA | Contention Based Random Access |
| CC | Component Carrier, |
| | Country Code, |
| | Cryptographic Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple Access |
| CFRA | Contention Free Random Access |
| CG | Cell Group |
| CGF | Charging Gateway Function |
| CHF | Charging Function |
| CI | Cell Identity |
| CID | Cell-ID (e.g., positioning method) |
| CIM | Common Information Model |
| CIR | Carrier to Interference Ratio |
| CK | Cipher Key |
| CM | Connection Management, |
| | Conditional Mandatory |
| CMAS | Commercial Mobile Alert Service |
| CMD | Command |
| CMS | Cloud Management System |
| CO | Conditional Optional |
| CoMP | Coordinated Multi-Point |
| CORESET | Control Resource Set |
| COTS | Commercial Off-The-Shelf |
| CP | Control Plane, |
| | Cyclic Prefix, |
| | Connection Point |
| CPD | Connection Point Descriptor |
| CPE | Customer Premise Equipment |
| CPICH | Common Pilot Channel |
| CQI | Channel Quality Indicator |
| CPU | CSI processing unit, |
| | Central Processing Unit |
| C/R | Command/Response field bit |
| CRAN | Cloud Radio Access Network, |
| | Cloud RAN |
| CRB | Common Resource Block |
| CRC | Cyclic Redundancy Check |
| CRI | Channel-State Information Resource Indicator, |
| | CSI-RS Resource Indicator |
| C-RNTI | Cell RNTI |
| CS | Circuit Switched |
| CSAR | Cloud Service Archive |
| CSI | Channel-State Information |
| CSI-IM | CSI Interference Measurement |
| CSI-RS | CSI Reference Signal |
| CSI-RSRP | CSI reference signal received power |
| CSI-RSRQ | CSI reference signal received quality |
| CSI-SINR | CSI signal-to-noise and interference ratio |
| CSMA | Carrier Sense Multiple Access |
| CSMA/CA | CSMA with collision avoidance |
| CSS | Common Search Space, |
| | Cell-specific Search Space |
| CTF | Charging Trigger Function |
| CTS | Clear-to-Send |
| CW | Codeword |
| CWS | Contention Window Size |
| D2D | Device-to-Device |
| DC | Dual Connectivity, |
| | Direct Current |
| DCI | Downlink Control Information |
| DF | Deployment Flavour |
| DL | Downlink |
| DMTF | Distributed Management Task Force |
| DPDK | Data Plane Development Kit |
| DM-RS, | Demodulation Reference Signal |
| DMRS | |
| DN | Data network |
| DNN | Data Network Name |
| DNAI | Data Network Access Identifier |
| DRB | Data Radio Bearer |
| DRS | Discovery Reference Signal |
| DRX | Discontinuous Reception |
| DSL | Domain Specific Language. |
| | Digital Subscriber Line |
| DSLAM | DSL Access Multiplexer |
| DwPTS | Downlink Pilot Time Slot |
| E-LAN | Ethernet Local Area Network |
| E2E | End-to-End |
| ECCA | extended clear channel assessment, |
| | extended CCA |
| ECCE | Enhanced Control Channel Element, |
| | Enhanced CCE |
| ED | Energy Detection |
| EDGE | Enhanced Datarates for GSM Evolution |
| | (GSM Evolution) |
| EAS | Edge Application Server |
| EASID | Edge Application Server Identification |
| ECS | Edge Configuration Server |
| ECSP | Edge Computing Service Provider |
| EDN | Edge Data Network |
| EEC | Edge Enabler Client |
| EECID | Edge Enabler Client Identification |
| EES | Edge Enabler Server |
| EESID | Edge Enabler Server Identification |
| EHE | Edge Hosting Environment |
| EGMF | Exposure Governance tableManagement Function |
| EGPRS | Enhanced GPRS |
| EIR | Equipment Identity Register |
| eLAA | enhanced Licensed Assisted Access, |
| | enhanced LAA |
| EM | Element Manager |
| eMBB | Enhanced Mobile Broadband |
| EMS | Element Management System |
| eNB | evolved NodeB, |
| | E-UTRAN Node B |
| EN-DC | E-UTRA-NR Dual Connectivity |
| EPC | Evolved Packet Core |
| EPDCCH | enhanced PDCCH, |
| | enhanced Physical Downlink Control Cannel |
| EPRE | Energy per resource element |
| EPS | Evolved Packet System |
| EREG | enhanced REG, |
| | enhanced resource element groups |
| ETSI | European Telecommunications Standards Institute |
| ETWS | Earthquake and Tsunami Warning System |
| eUICC | embedded UICC, |
| | embedded Universal Integrated Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control CHannel |
| FACCH/F | Fast Associated Control Channel/Full rate |
| FACCH/H | Fast Associated Control Channel/Half rate |
| FACH | Forward Access Channel |
| FAUSCH | Fast Uplink Signalling Channel |
| FB | Functional Block |
| FBI | Feedback Information |
| FCC | Federal Communications Commission |
| FCCH | Frequency Correction CHannel |
| FDD | Frequency Division Duplex |
| FDM | Frequency Division Multiplex |
| FDMA | Frequency Division Multiple Access |
| FE | Front End |
| FEC | Forward Error Correction |
| FFS | For Further Study |
| FFT | Fast Fourier Transformation |
| feLAA | further enhanced Licensed Assisted Access, |
| | further enhanced LAA |
| FN | Frame Number |
| FPGA | Field-Programmable Gate Array |
| FR | Frequency Range |
| FQDN | Fully Qualified Domain Name |
| G-RNTI | GERAN Radio Network Temporary Identity |
| GERAN | GSM EDGE RAN, |
| | GSM EDGE Radio Access Network |
| GGSN | Gateway GPRS Support Node |
| GLONASS | GLObal'naya NAvigatsionnaya |
| | Sputnikovaya Sistema |
| | (Engl.: Global Navigation Satellite System) |
| gNB | Next Generation NodeB |
| gNB-CUgNB- | Next Generation NodeB centralized unit |
| centralized unit, | |
| gNB-DUgNB- | Next Generation NodeB distributed unit |
| distributed unit, | |
| GNSS | Global Navigation Satellite System |
| GPRS | General Packet Radio Service |
| GPSI | Generic Public Subscription Identifier |
| GSM | Global System for Mobile Communications, |
| | Groupe Spécial Mobile |
| GTP | GPRS Tunneling Protocol |
| GTP-U | GPRS Tunnelling Protocol for User Plane |
| GTS | Go To Sleep Signal (related to WUS) |
| GUMMEI | Globally Unique MME Identifier |
| GUTI | Globally Unique Temporary UE Identity |
| HARQ | Hybrid ARQ, |
| | Hybrid Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile Network |
| HSDPA | High Speed Downlink Packet Access |
| HSN | Hopping Sequence Number |
| HSPA | High Speed Packet Access |
| HSS | Home Subscriber Server |
| HSUPA | High Speed Uplink Packet Access |
| HTTP | Hyper Text Transfer Protocol |
| HTTPS | Hyper Text Transfer Protocol Secure |
| | (https is http/1.1 over SSL, i.e. port 443) |
| I-Block | Information Block |
| ICCID | Integrated Circuit Card Identification |
| IAB | Integrated Access and Backhaul |
| ICIC | Inter-Cell Interference Coordination |
| ID | Identity, identifier |
| IDFT | Inverse Discrete Fourier Transform |
| IE | Information element |
| IBE | In-Band Emission |
| IEEE | Institute of Electrical and Electronics Engineers |
| IEI | Information Element Identifier |
| IEIDL | Information Element Identifier Data Length |
| IETF | Internet Engineering Task Force |
| IF | Infrastructure |
| IM | Interference Measurement, |
| | Intermodulation, |
| | IP Multimedia |
| IMC | IMS Credentials |
| IMEI | International Mobile Equipment Identity |
| IMGI | International mobile group identity |
| IMPI | IP Multimedia Private Identity |
| IMPU | IP Multimedia PUblic identity |
| IMS | IP Multimedia Subsystem |
| IMSI | International Mobile Subscriber Identity |
| IoT | Internet of Things |
| IP | Internet Protocol |
| Ipsec | IP Security, |
| | Internet Protocol Security |
| IP-CAN | IP-Connectivity Access Network |
| IP-M | IP Multicast |
| IPv4 | Internet Protocol Version 4 |
| IPv6 | Internet Protocol Version 6 |
| IR | Infrared |
| IS | In Sync |
| IRP | Integration Reference Point |
| ISDN | Integrated Services Digital Network |
| ISIM | IM Services Identity Module |
| ISO | International Organisation for Standardisation |
| ISP | Internet Service Provider |
| IWF | Interworking-Function |
| I-WLAN | Interworking WLAN |
| | Constraint length of the |
| | convolutional code, |
| | USIM Individual key |
| kB | Kilobyte (1000 bytes) |
| kbps | kilo-bits per second |
| Kc | Ciphering key |
| Ki | Individual subscriber authentication key |
| KPI | Key Performance Indicator |
| KQI | Key Quality Indicator |
| KSI | Key Set Identifier |
| ksps | kilo-symbols per second |
| KVM | Kernel Virtual Machine |
| L1 | Layer 1 (physical layer) |
| L1-RSRP | Layer 1 reference signal received power |
| L2 | Layer 2 (data link layer) |
| L3 | Layer 3 (network layer) |
| LAA | Licensed Assisted Access |
| LAN | Local Area Network |
| LADN | Local Area Data Network |
| LBT | Listen Before Talk |
| LCM | LifeCycle Management |
| LCR | Low Chip Rate |
| LCS | Location Services |
| LCID | Logical Channel ID |
| LI | Layer Indicator |
| LLC | Logical Link Control, |
| | Low Layer Compatibility |
| LPLMN | Local PLMN |
| LPP | LTE Positioning Protocol |
| LSB | Least Significant Bit |
| LTE | Long Term Evolution |
| LWA | LTE-WLAN aggregation |
| LWIP | LTE/WLAN Radio Level Integration |
| | with IPsec Tunnel |
| LTE | Long Term Evolution |
| M2M | Machine-to-Machine |
| MAC | Medium Access Control |
| | (protocol layering context) |
| MAC | Message authentication code |
| | (security/encryption context) |
| MAC-A | MAC used for authentication and key |
| | agreement (TSG T WG3 context) |
| MAC-I | MAC used for data integrity of signalling |
| | messages (TSG T WG3 context) |
| MANO | Management and Orchestration |
| MBMS | Multimedia Broadcast and Multicast Service |
| MBSFN | Multimedia Broadcast multicast |
| | service Single Frequency Network |
| MCC | Mobile Country Code |
| MCG | Master Cell Group |
| MCOT | M11imum Channel Occupancy Time |
| MCS | Modulation and coding scheme |
| MDAF | Management Data Analytics Function |
| MDAS | Management Data Analytics Service |
| MDT | Minimization of Drive Tests |
| ME | Mobile Equipment |
| MeNB | master eNB |
| MER | Message Error Ratio |
| MGL | Measurement Gap Length |
| MGRP | Measurement Gap Repetition Period |
| MIB | Master Information Block, |
| | Management Information Base |
| MIMO | Multiple Input Multiple Output |
| MLC | Mobile Location Centre |
| MM | Mobility Management |
| MME | Mobility Management Entity |
| MN | Master Node |
| MNO | Mobile Network Operator |
| MO | Measurement Object, |
| | Mobile Originated |
| MPBCH | MTC Physical |
| | Broadcast CHannel |
| MPDCCH | MTC Physical Downlink Control CHannel |
| MPDSCH | MTC Physical Downlink Shared CHannel |
| MPRACH | MTC Physical Random Access CHannel |
| MPUSCH | MTC Physical Uplink Shared Channel |
| MPLS | MultiProtocol Label Switching |
| MS | Mobile Station |
| MSB | Most Significant Bit |
| MSC | Mobile Switching Centre |
| MSI | Minimum System Information, |
| | MCH Scheduling Information |
| MSID | Mobile Station Identifier |
| MSIN | Mobile Station Identification Number |
| MSISDN | Mobile Subscriber ISDN Number |
| MT | Mobile Terminated, |
| | Mobile Termination |
| MTC | Machine-Type Communications |
| mMTC | massive MTC, |
| | massive Machine-Type Communications |
| MU-MIMO | Multi User MIMO |
| MWUS | MTC wake-up signal, |
| | MTC WUS |
| NACK | Negative Acknowledgement |
| NAI | Network Access Identifier |
| NAS | Non-Access Stratum, |
| | Non-Access Stratum layer |
| NCT | Network Connectivity Topology |
| NC-JT | Non-Coherent Joint Transmission |
| NEC | Network Capability Exposure |
| NE-DC | NR-E-UTRA Dual Connectivity |
| NEF | Network Exposure Function |
| NF | Network Function |
| NFP | Network Forwarding Path |
| NFPD | Network Forwarding Path Descriptor |
| NFV | Network Functions Virtualization |
| NFVI | NFV Infrastructure |
| NFVO | NFV Orchestrator |
| NG | Next Generation, |
| | Next Gen |
| NGEN-DC | NG-RAN E-UTRA-NR Dual Connectivity |
| NM | Network Manager |
| NMS | Network Management System |
| N-PoP | Network Point of Presence |
| NMIB, N-MIB | Narrowband MIB |
| NPBCH | Narrowband Physical Broadcast CHannel |
| NPDCCH | Narrowband Physical Downlink Control CHannel |
| NPDSCH | Narrowband Physical Downlink Shared CHannel |
| NPRACH | Narrowband Physical Random Access CHannel |
| NPUSCH | Narrowband Physical Uplink Shared CHannel |
| NPSS | Narrowband Primary Synchronization Signal |
| NSSS | Narrowband Secondary Synchronization Signal |
| NR | New Radio, |
| | Neighbour Relation |
| NRF | NF Repository Function |
| NRS | Narrowband Reference Signal |
| NS | Network Service |
| NSA | Non-Standalone operation mode |
| NSD | Network Service Descriptor |
| NSR | Network Service Record |
| NSSAI | Network Slice Selection Assistance Information |
| S-NNSAI | Single-NSSAI |
| NSSF | Network Slice Selection Function |
| NW | Network |
| NWUS | Narrowband wake-up signal, |
| | Narrowband WUS |
| NZP | Non-Zero Power |
| O&M | Operation and Maintenance |
| ODU2 | Optical channel Data Unit-type 2 |
| OFDM | Orthogonal Frequency Division Multiplexing |
| OFDMA | Orthogonal Frequency Division Multiple Access |
| OOB | Out-of-band |
| OOS | Out of Sync |
| OPEX | OPerating EXpense |
| OSI | Other System Information |
| OSS | Operations Support System |
| OTA | over-the-air |
| PAPR | Peak-to-Average Power Ratio |
| PAR | Peak to Average Ratio |
| PBCH | Physical Broadcast Channel |
| PC | Power Control, |
| | Personal Computer |
| PCC | Primary Component Carrier, |
| | Primary CC |
| PCell | Primary Cell |
| PCI | Physical Cell ID, |
| | Physical Cell Identity |
| PCEF | Policy and Charging Enforcement Function |
| PCF | Policy Control Function |
| PCRF | Policy Control and Charging Rules Function |
| PDCP | Packet Data Convergence Protocol, |
| | Packet Data Convergence Protocol layer |
| PDCCH | Physical Downlink Control Channel |
| PDCP | Packet Data Convergence Protocol |
| PDN | Packet Data Network, |
| | Public Data Network |
| PDSCH | Physical Downlink Shared Channel |
| PDU | Protocol Data Unit |
| PEI | Permanent Equipment Identifiers |
| PFD | Packet Flow Description |
| P-GW | PDN Gateway |
| PHICH | Physical hybrid-ARQ indicator channel |
| PHY | Physical layer |
| PLMN | Public Land Mobile Network |
| PIN | Personal Identification Number |
| PM | Performance Measurement |
| PMI | Precoding Matrix Indicator |
| PNF | Physical Network Function |
| PNFD | Physical Network Function Descriptor |
| PNFR | Physical Network Function Record |
| POC | PTT over Cellular |
| PP, PTP | Point-to-Point |
| PPP | Point-to-Point Protocol |
| PRACH | Physical RACH |
| PRB | Physical resource block |
| PRG | Physical resource block group |
| ProSe | Proximity Services, |
| | Proximity-Based Service |
| PRS | Positioning Reference Signal |
| PRR | Packet Reception Radio |
| PS | Packet Services |
| PSBCH | Physical Sidelink Broadcast Channel |
| PSDCH | Physical Sidelink Downlink Channel |
| PSCCH | Physical Sidelink Control Channel |
| PSSCH | Physical Sidelink Shared Channel |
| PSCell | Primary SCell |
| PSS | Primary Synchronization Signal |
| PSTN | Public Switched Telephone Network |
| PT-RS | Phase-tracking reference signal |
| PTT | Push-to-Talk |
| PUCCH | Physical Uplink Control Channel |
| PUSCH | Physical Uplink Shared Channel |
| QAM | Quadrature Amplitude Modulation |
| QCI | QoS class of identifier |
| QCL | Quasi co-location |
| QFI | QoS Flow ID, |
| | QoS Flow Identifier |
| QoS | Quality of Service |
| QPSK | Quadrature (Quaternary) Phase Shift Keying |
| QZSS | Quasi-Zenith Satellite System |
| RA-RNTI | Random Access RNTI |
| RAB | Radio Access Bearer, |
| | Random Access Burst |
| RACH | Random Access Channel |
| RADIUS | Remote Authentication Dial In User Service |
| RAN | Radio Access Network |
| RAND | RANDom number (used for authentication) |
| RAR | Random Access Response |
| RAT | Radio Access Technology |
| RAU | Routing Area Update |
| RB | Resource block, |
| | Radio Bearer |
| RBG | Resource block group |
| REG | Resource Element Group |
| Rel | Release |
| REQ | REQuest |
| RF | Radio Frequency |
| RI | Rank Indicator |
| RIV | Resource indicator value |
| RL | Radio Link |
| RLC | Radio Link Control, |
| | Radio Link Control layer |
| RLC AM | RLC Acknowledged Mode |
| RLC UM | RLC Unacknowledged Mode |
| RLF | Radio Link Failure |
| RLM | Radio Link Monitoring |
| RLM-RS | Reference Signal for RLM |
| RM | Registration Management |
| RMC | Reference Measurement Channel |
| RMSI | Remaining MSI, |
| | Remaining Minimum System Information |
| RN | Relay Node |
| RNC | Radio Network Controller |
| RNL | Radio Network Layer |
| RNTI | Radio Network Temporary Identifier |
| ROHC | RObust Header Compression |
| RRC | Radio Resource Control, |
| | Radio Resource Control layer |
| RRM | Radio Resource Management |
| RS | Reference Signal |
| RSRP | Reference Signal Received Power |
| RSRQ | Reference Signal Received Quality |
| RSSI | Received Signal Strength Indicator |
| RSU | Road Side Unit |
| RSTD | Reference Signal Time difference |
| RTP | Real Time Protocol |
| RTS | Ready-To-Send |
| RTT | Round Trip Time |
| Rx | Reception, Receiving, Receiver |
| S1AP | S1 Application Protocol |
| S1-MMES1 | for the control plane |
| S1-U | S1 for the user plane |
| S-GW | Serving Gateway |
| S-RNTI | SRNC Radio Network Temporary Identity |
| S-TMSI | SAE Temporary Mobile Station Identifier |
| SA | Standalone operation mode |
| SAE | System Architecture Evolution |
| SAP | Service Access Point |
| SAPD | Service Access Point Descriptor |
| SAPI | Service Access Point Identifier |
| SCC | Secondary Component Carrier, Secondary CC |
| SCell | Secondary Cell |
| SCEF | Service Capability Exposure Function |
| SC-FDMA | Single Carrier Frequency Division Multiple Access |
| SCG | Secondary Cell Group |
| SCM | Security Context Management |
| SCS | Subcarrier Spacing |
| SCTP | Stream Control Transmission Protocol |
| SDAP | Service Data Adaptation Protocol, |
| | Service Data Adaptation Protocol layer |
| SDL | Supplementary Downlink |
| SDNF | Structured Data Storage Network Function |
| SDP | Session Description Protocol |
| SDSF | Structured Data Storage Function |
| SDU | Service Data Unit |
| SEAF | Security Anchor Function |
| SeNB | secondary eNB |
| SEPP | Security Edge Protection Proxy |
| SFI | Slot format indication |
| SFTD | Space-Frequency Time Diversity, |
| | SFN and frame timing difference |
| SFN | System Frame Number |
| SgNB | Secondary gNB |
| SGSN | Serving GPRS Support Node |
| S-GW | Serving Gateway |
| SI | System Information |
| SI-RNTI | System Information RNTI |
| SIB | System Information Block |
| SIM | Subscriber Identity Module |
| SIP | Session Initiated Protocol |
| SiP | System in Package |
| SL | Sidelink |
| SLA | Service Level Agreement |
| SM | Session Management |
| SMF | Session Management Function |
| SMS | Short Message Service |
| SMSF | SMS Function |
| SMTC | SSB-based Measurement Timing Configuration |
| SN | Secondary Node, |
| | Sequence Number |
| SoC | System on Chip |
| SON | Self-Organizing Network |
| SpCell | Special Cell |
| SP-CSI-RNTI | Semi-Persistent CSI RNTI |
| SPS | Semi-Persistent Scheduling |
| SQN | Sequence number |
| SR | Scheduling Request |
| SRB | Signalling Radio Bearer |
| SRS | Sounding Reference Signal |
| SS | Synchronization Signal |
| SSB | Synchronization Signal Block |
| SSID | Service Set Identifier |
| SS/PBCH | Block |
| SSBRI | SS/PBCH Block Resource Indicator, |
| | Synchronization Signal Block Resource Indicator |
| SSC | Session and Service Continuity |
| SS-RSRP | Synchronization Signal based Reference Signal |
| | Received Power |
| SS-RSRQ | Synchronization Signal based Reference Signal |
| | Received Quality |
| SS-SINR | Synchronization Signal based Signal to Noise |
| | and Interference Ratio |
| SSS | Secondary Synchronization Signal |
| SSSG | Search Space Set Group |
| SSSIF | Search Space Set Indicator |
| SST | Slice/Service Types |
| SU-MIMO | Single User MIMO |
| SUL | Supplementary Uplink |
| TA | Timing Advance, |
| | Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission Configuration Indicator |
| TCP | Transmission Communication Protocol |
| TDD | Time Division Duplex |
| TDM | Time Division Multiplexing |
| TDMA | Time Division Multiple Access |
| TE | Terminal Equipment |
| TEID | Tunnel End Point Identifier |
| TFT | Traffic Flow Template |
| TMSI | Temporary Mobile Subscriber Identity |
| TNL | Transport Network Layer |
| TPC | Transmit Power Control |
| TPMI | Transmitted Precoding Matrix Indicator |
| TR | Technical Report |
| TRP, TRxP | Transmission Reception Point |
| TRS | Tracking Reference Signal |
| TRx | Transceiver |
| TS | Technical Specifications, |
| | Technical Standard |
| TTI | Transmission Time Interval |
| Tx | Transmission, |
| | Transmitting, |
| | Transmitter |
| U-RNTI | UTRAN Radio Network Temporary Identity |
| UART | Universal Asynchronous Receiver and Transmitter |
| UCI | Uplink Control Information |
| UE | User Equipment |
| UDM | Unified Data Management |
| UDP | User Datagram Protocol |
| UDSF | Unstructured Data Storage Network Function |
| UICC | Universal Integrated Circuit Card |
| UL | Uplink |
| UM | Unacknowledged Mode |
| UML | Unified Modelling Language |
| UMTS | Universal Mobile Telecommunications System |
| UP | User Plane |
| UPF | User Plane Function |
| URI | Uniform Resource Identifier |
| URL | Uniform Resource Locator |
| URLLC | Ultra-Reliable and Low Latency |
| USB | Universal Serial Bus |
| USIM | Universal Subscriber Identity Module |
| USS | UE-specific search space |
| UTRA | UMTS Terrestrial Radio Access |
| UTRAN | Universal Terrestrial Radio Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized Infrastructure Manager |
| VL | Virtual Link, |
| VLAN | Virtual LAN, |
| | Virtual Local Area Network |
| VM | Virtual Machine |
| VNF | Virtualized Network Function |
| VNFFG | VNF Forwarding Graph |
| VNFFGD | VNF Forwarding Graph Descriptor |
| VNFM | VNF Manager |
| VOIP | Voice-over-IP, |
| | Voice-over-Internet Protocol |
| VPLMN | Visited Public Land Mobile Network |
| VPN | Virtual Private Network |
| VRB | Virtual Resource Block |
| WiM11 | Worldwide Interoperability for Microwave Access |
| WLAN | Wireless Local Area Network |
| WMAN | Wireless Metropolitan Area Network |
| WPAN | Wireless Personal Area Network |
| X2-C | X2-Control plane |
| X2-U | X2-User plane |
| XML | eXtensible Markup Language |
| XRES | EXpected user RESponse |
| XOR | exclusive OR |
| ZC | Zadoff-Chu |
| ZP | Zero Po |

What is claimed is:

1. An apparatus of a Service Based Management Architecture (SBMA) Management Service (MnS) Producer, the apparatus comprising processing circuitry coupled to storage for storing information associated with performance measurements for one-way uplink packet delay in wireless communications, the processing circuitry configured to:
identify performance measurements, received from a network function (NF) of a 5^{th} Generation (5G) wireless network, indicative of uplink packet delay between a user equipment (UE) and a protocol data unit (PDU) session anchor (PSA) user plane function (UPF) of the 5G wireless network;
detect whether the performance measurements indicate that the uplink packet delay includes an uplink Packet Data Convergence Protocol (PDCP) delay occurred in the UE (D1); and
generate performance metrics for the NF based on the performance measurements.

2. The apparatus of claim 1, wherein the uplink packet delay comprises a radio access network (RAN) delay and a core network (CN) delay.

3. The apparatus of claim 1, wherein the processing circuitry is further configured to provide the performance metrics to an MnS consumer.

4. The apparatus of claim 1, wherein the MnS Producer is implemented within the NF.

5. The apparatus of claim 1, wherein the MnS Producer is implemented within a second NF different than the NF.

6. The apparatus of claim 1, wherein the uplink packet delay is an average uplink packet delay not including the D1.

7. The apparatus of claim 6, wherein the average uplink packet delay not including the D1 is received from a UPF and generated by the UPF by:
performing, by the UPF, Quality of Service (QOS) monitoring based on a request received from a session management function (SMF) of the 5G wireless network during a PDU Session Establishment or Modification procedure, wherein for each received General Packet Radio Service (GPRS) Tunneling Protocol (GTP) PDU monitoring response packet (packet i) for QoS monitoring, the PSA UPF records the following time stamps and information:
T3 received in a GTP-U header of the monitoring response packet, indicating a local time that the monitoring response packet was sent by a Next Generation RAN (NG-RAN),
T4 indicating that the monitoring response packet was received by the PSA UPF,
a UL Delay Result from the UE to the NG-RAN indicating an uplink delay measurement result that is a sum of a delay incurred in the NG-RAN, including a delay at a 5G Next Generation base station (gNB)-Central Unit User Plane (UP) (gNB-CU-UP), on an an F1-U interface, and on a gNB Distributed Unit (gNB-DU), and a delay over an Uu interface, excluding a D1 UL PDCP delay occurred in the UE,
wherein a Single-Network Slice Selection Assistance (S-NSSAI) is associated to the GTP PDU monitoring response packet, and
wherein the PSA UPF counts a number (N) of GTP PDU monitoring response packets for each S-NSSAI, and calculates a respective S-NSSAI for each GTP PDU monitoring response packet.

8. The apparatus of claim 1, wherein the uplink packet delay is a distribution of uplink packet delay not including the D1.

9. The apparatus of claim 8, wherein the distribution of uplink packet delay not including the D1 is received from a UPF and generated by the UPF by:
performing, by the UPF, QoS monitoring based on a request received from an SMF of the 5G wireless network during an PDU Session Establishment or Modification procedure, wherein for each received GTP PDU monitoring response packet (packet i) for QoS monitoring, the PSA UPF records the following time stamps and information:
T3 received in a GTP-U header of the monitoring response packet, indicating a local time that the monitoring response packet was sent by an NG-RAN,
T4 indicating that the monitoring response packet was received by the PSA UPF,
a UL Delay Result from the UE to the NG-RAN indicating an uplink delay measurement result that is a sum of the delay incurred in NG-RAN, including a delay at an gNB-CU-UP, on an F1-U interface, and on a gNB-DU, and a delay over an Uu interface, excluding the D1 UL PDCP delay occurred in the UE,
wherein an S-NSSAI is associated to the GTP PDU monitoring response packet, and
wherein the PSA UPF performs a calculation for each GTP PDU monitoring response packet (packet i) for each S-NSSAI, and increments a corresponding bin with a delay range in which a result of the respective calculation falls into by 1 for a subcounter per the S-NSSAI.

10. The apparatus of claim 1, wherein the uplink packet delay is an average uplink packet delay including the D1.

11. The apparatus of claim 10, wherein the average uplink packet delay including D1 is received from a UPF and is generated by the UPF by:
performing, by the UPF, QoS monitoring based on a request received from an SMF of the 5G wireless network during a PDU Session Establishment or Modification procedure, wherein for each received GTP PDU monitoring response packet (packet i) for QoS monitoring, the PSA UPF records the following time stamps and information:
T3 received in a GTP-U header of the monitoring response packet, indicating a local time that the monitoring response packet was sent by an NG-RAN,
T4 indicating that the monitoring response packet was received by the PSA UPF,
a UL Delay Result from the UE to the NG-RAN, indicating an uplink delay measurement result that is a sum of a delay incurred in the NG-RAN, including a delay at agNB-CU-UP, on an F1-U interface, and on a gNB-DU, and a delay over an Uu interface, wherein the D1 UL PDCP delay occurred in the UE, and
an S-NSSAI associated to the GTP PDU monitoring response packet,
wherein the PSA UPF counts a number (N) of GTP PDU monitoring response packets for each S-NSSAI, and performs a calculation for each S-NSSAI.

12. The apparatus of claim 1, wherein the uplink packet delay is a distribution of uplink packet delay including the D1.

13. The apparatus of claim 12, wherein the distribution of uplink packet delay including D1 is received from a UPF and is generated by the UPF by:
performing, by the UPF, QOS monitoring per a request received from an SMF during a PDU Session Establishment or Modification procedure, wherein for each received GTP PDU monitoring response packet (packet i) for QoS monitoring, the PSA UPF records the following time stamps and information:
T3 received in a GTP-U header of the monitoring response packet, indicating a local time that the monitoring response packet was sent by an NG-RAN;
T4 indicating that the monitoring response packet was received by the PSA UPF,
a UL Delay Result from the UE to the NG-RAN, indicating the uplink delay measurement result that is a sum of a delay incurred in the NG-RAN, including a delay at a gNB-CU-UP, on an F1-U interface, and on a gNB-DU, and a delay over an Uu interface, and the D1 UL PDCP delay occurred in the UE, and
an S-NSSAI associated to the GTP PDU monitoring response packet,
wherein the PSA UPF performs a calculation for each GTP PDU monitoring response packet (packet i) for each S-NSSAI, and increments a corresponding bin with a delay range in which the result of the respective calculation falls into by 1 for a subcounter per S-NSSAI.

14. A non-transitory computer-readable storage medium comprising instructions to cause processing circuitry of a Service Based Management Architecture (SBMA) Management Service (MnS) Producer for performing performance measurements for one-way uplink packet delay in wireless communications, upon execution of the instructions by the processing circuitry, to:
identify performance measurements, received from a network function (NF) of a 5th Generation (5G) wireless network, indicative of uplink packet delay between a user equipment (UE) and a protocol data unit (PDU) session anchor (PSA) user plane function (UPF) of the 5G wireless network;
detect whether the performance measurements indicate that the uplink packet delay includes an uplink PDCP delay occurred in the UE (D1); and
generate performance metrics for the NF based on the performance measurements.

15. The non-transitory computer-readable storage medium of claim 14, wherein the uplink packet delay comprises a radio access network (RAN) delay and a core network (CN) delay.

16. The non-transitory computer-readable storage medium of claim 14, wherein the processing circuitry is further configured to provide the performance metrics to an MnS Consumer.

17. The non-transitory computer-readable storage medium of claim 14, wherein the MnS Producer is implemented within the NF.

18. A method for performing performance measurements for one-way uplink packet delay in wireless communications, the method comprising:
identifying, by processing circuitry of a Service Based Management Architecture (SBMA) Management Service (MnS) Producer, a precoder rank indicator for use in an eight-transmitter uplink transmission by a UE device, performance measurements, received from a network function (NF) of a 5th Generation (5G) wireless network, indicative of uplink packet delay between a user equipment (UE) and a protocol data unit (PDU) session anchor (PSA) user plane function (UPF) of the 5G wireless network;
detecting, by the processing circuitry, whether the performance measurements indicate that the uplink packet delay includes an uplink PDCP delay occurred in the UE (D1); and
generating, by the processing circuitry, performance metrics for the NF based on the performance measurements.

19. A non-transitory computer-readable storage medium comprising instructions to perform the method of claim 18.

20. An apparatus comprising means for performing the method of claim 18.
